(19) United States
(12) Patent Application Publication
(10) Pub. No.: US 2026/0298651 A1
(43) Pub. Date: Oct. 1, 2026

(54) INFORMATION PROJECTION APPARATUS

(71) Applicant: Maxell, Ltd., Kyoto (JP)

(72) Inventors: Sho ASAKURA, Otokuni-gun (JP); Yasuhiko KUNII, Otokuni-gun (JP); Chiaki KINNO, Kyoto (JP)

(21) Appl. No.: 19/629,789

(22) Filed: Mar. 26, 2026

(30) Foreign Application Priority Data
Mar. 27, 2025 (JP) 2025-054651
Mar. 28, 2025 (JP) 2025-057330

(51) Int. Cl. G01C 21/36; B60W 50/14; G06V 20/58; H04N 5/74

(52) U.S. Cl. CPC G01C 21/365; B60W 50/14; G06V 20/58; H04N 5/74

(57) ABSTRACT

To provide technology that enables more appropriate display of images for the driver and images for people around the vehicle. This invention contributes to Sustainable Development Goal 3: Good Health and Well-Being. An information projection apparatus is mounted on a vehicle, and projects images onto the road surface. The information projection apparatus is configured to a receiver for acquiring information related to the vehicle, and an image projector for projecting an image. When the vehicle is reversing, the information projection apparatus acquires detection information relating to obstacles around the vehicle using the receiver, and projects an image based on the detected information.

### CROSS-REFERENCE TO RELATED APPLICATION

The present application claims priority from Japanese applications JP2025-054651, filed on Mar. 27, 2025, and 2025-057330 filed Mar. 28, 2025, the contents of which are hereby incorporated by reference into this application.

### BACKGROUND OF THE INVENTION

### 1. Field of the Invention

The present invention relates to an information projection apparatus.

### 2. Description of the Related Art

As shown in Patent Document 1 and Patent Document 2, techniques for projecting information onto road surfaces are known.

JP-A-2012-247369 discloses a vehicle projection device that projects route guidance images onto the road surface ahead of the vehicle. This vehicle projection device includes route search means for searching the current position of the vehicle and a route from said current position to a set destination, and projection means for projecting a route guidance image onto the road surface in front of the vehicle, based on the route information searched by said route search means, to guide the vehicle toward a branch direction, when the vehicle approaches a branch point on said route to a degree visible to occupants.

JP-A-2008-7079 discloses a technology capable of clearly alerting moving objects such as pedestrians, disclosing a road surface projection method as one example. This road surface projection method includes a step of storing image data of an image to be projected onto the road surface in advance, a step of monitoring the area surrounding the vehicle, a step of identifying a moving object based on the monitoring result, and a step of setting an identification area within the monitored surrounding area, and reading out the stored image data in advance when the identified moving object is present within the identification area, and projecting the image onto the road surface position near the moving object.

There is a need to provide technology that enables more appropriate display of images for the driver and images for vehicles around the vehicle and people.

### SUMMARY OF THE INVENTION

According to an embodiment of the present invention, an information projection apparatus is mounted on a vehicle, and projects images onto the road surface. The information projection apparatus is configured to a receiver for acquiring information related to the vehicle, and an image projector for projecting an image. When the vehicle is reversing, the information projection apparatus acquires detection information relating to obstacles around the vehicle using the receiver, and projects an image based on the detected information.

### Advantageous Effect

According to the present invention, a technology is provided that enables more appropriate display of images for the driver and images for vehicles around the vehicle and people. Note that, other issues, configurations, and effects not mentioned above will become apparent from the description of embodiments for implementing the invention.

### BRIEF DESCRIPTION OF THE DRAWINGS

FIG. 1 is a diagram showing an example of an overview of a vehicle implementing an information projection apparatus.

FIG. 2 is a diagram showing an example of configuration provided in the vehicle.

FIG. 3A is a diagram showing an example of an image display when projecting information onto the road surface in front of the vehicle.

FIG. 3B is a diagram showing an example of an image display when projecting information onto the road surface behind the vehicle.

FIG. 4A is a diagram showing an example of a configuration of the projection apparatus.

FIG. 4B is a diagram showing an example of a configuration of the projection apparatus.

FIG. 4C is a diagram showing an example of a configuration of the projection apparatus.

FIG. 5A is a diagram illustrating an example of the arrangement of optical components and the like.

FIG. 5B is a diagram illustrating an example of the arrangement of optical components and the like.

FIG. 5C is a diagram illustrating an example of the arrangement of optical components and the like.

FIG. 6 is a diagram showing an example of a display area for images as seen by the driver.

FIG. 7 is a diagram illustrating an example of a display area where an image light is projected.

FIG. 8 is a diagram illustrating an example of an embodiment regarding information projection.

FIG. 9 is a diagram illustrating a method for detecting obstacles in each area.

FIG. 10 is a diagram illustrating image projection according to the presence area of an object.

FIG. 11A is a diagram illustrating an example of projecting an image according to an area.

FIG. 11B is a diagram illustrating an example of projecting an image according to an area.

FIG. 11C is a diagram illustrating an example of projecting an image according to the area.

FIG. 11D is a diagram illustrating an example of projecting an image according to an area.

FIG. 12A is a diagram illustrating a modified example of projecting an image according to an area.

FIG. 12B is a diagram illustrating a modified example of projecting an image according to an area.

FIG. 12C is a diagram illustrating a modified example of projecting an image according to an area.

FIG. 13A is a diagram illustrating a modified example of projecting an image according to an area.

FIG. 13B is a diagram illustrating a modified example of projecting an image according to an area.

FIG. 13C is a diagram illustrating a modified example for projecting an image according to an area.

FIG. 14A is a diagram illustrating a modified example for projecting an image according to an area.

FIG. 14B is a diagram illustrating a modified example of projecting an image according to an area.

FIG. 15 is a diagram illustrating an example flow for projecting information.

FIG. 16 is a diagram illustrating an example of a table showing objects.

FIG. 17 is a diagram illustrating an example of an embodiment projecting images when the vehicle is reversing.

FIG. 18 is a diagram illustrating an example of detection distance and danger level.

FIG. 19 is a diagram illustrating an example of projection based on an object.

FIG. 20A is a diagram illustrating an example of the positional relationship between the vehicle and a detected object.

FIG. 20B is a diagram illustrating an example of the positional relationship between the vehicle and the detected object.

FIG. 20C is a diagram illustrating an example of the positional relationship between the vehicle and the detected object.

FIG. 21A is a diagram illustrating an example of projecting an image according to the position of the object.

FIG. 21B is a diagram illustrating an example of projecting an image according to the position of the object.

FIG. 21C is an illustration for explaining an example of projecting an image according to the position of the object.

FIG. 21D is an illustration for explaining an example of projecting an image according to the position of the object.

FIG. 21E is an illustration for explaining an example of projecting an image according to the position of the object.

FIG. 21F is an illustration for explaining an example of projecting an image according to the position of the object.

FIG. 22 is a diagram illustrating a modified example for projecting an image when the vehicle is reversing.

FIG. 23 is a diagram illustrating an example of indicating a danger level according to an object.

FIG. 24 is a diagram illustrating an example of projection based on the object.

FIG. 25A is a diagram illustrating an example showing the movement direction and speed of the object and vehicle.

FIG. 25B is a diagram illustrating an example showing the movement direction and speed of the object and vehicle.

FIG. 25C is a diagram illustrating an example showing the movement direction and speed of the object and vehicle.

FIG. 25D is a diagram illustrating an example showing the movement direction and speed of an object and a vehicle.

### MODE FOR CARRYING OUT THE INVENTION

Hereinafter, the embodiments of the present invention will be described with reference to the drawings. The embodiments are examples for illustrating the present invention, and omissions and simplifications have been made as appropriate for clarity of explanation. The present invention may be implemented in various other forms. Unless specifically limited, each element may be singular or plural.

The positions, such as positions, sizes, shapes, and ranges of the components shown in the drawings may not represent their actual positions, such as sizes, shapes, or ranges, intended to facilitate understanding of the invention. Therefore, the invention is not necessarily limited to the positions, sizes, shapes, or ranges disclosed in the drawings.

Various types of information may be described using expressions such as "table," "list," or "queue," but such information may also be represented using other data structures. For example, information such as "XX table," "XX list," or "XX queue" may also be referred to as "XX information." When describing identification information, terms like "identification information," "identifier," "name," "ID," or "number" are used, and these terms are replaceable.

When multiple components have identical or similar functions, they may be described using the same symbol with different subscripts. Conversely, when no distinction between these multiple components is necessary, the subscript may be omitted in the description.

In the embodiments, processing performed by executing a program may be described. Here, a computer executes the program using a processor (e.g., CPU, GPU), utilizing storage resources (e.g., memory) and interface devices (e.g., communication ports), to perform the processing defined by the program. Therefore, the processor may be considered the processing subject performing executed by the program. Similarly, the processing subject performing executed by the program, may be a controller, device, system, computer, or node that includes a processor. The processing subject performing executed by the program, may be an arithmetic unit and may include dedicated circuits for performing specific processing. Here, dedicated circuits is, for example, FPGA (Field Programmable Gate Arrays) or ASIC (Application Specific Integrated Circuit), CPLD (Complex Programmable Logic Device), etc.

The program may be installed on a computer from a program source. The program source may be, for example, a program distribution server or a computer-readable storage medium. When the program source is a program distribution server, the program distribution server includes a processor and storage resources for storing the program to be distributed, and the processor of the program distribution server may distribute the program to other computers. Furthermore, in embodiments, two or more programs may be implemented as a single program, or a single program may be implemented as two or more programs.

The embodiment describes an example of a technique for displaying information on the road surface using a projection apparatus mounted on a vehicle. Note that, in the embodiment, for the vehicle and driver, the horizontal direction refers to the left-right direction, the vehicle's lateral direction, or the vehicle's width direction, the vertical direction refers to the vehicle's up-down direction or longitudinal direction, and the vertical direction perpendicular to the vehicle's lateral direction refers to the vehicle's front-rear direction or the vehicle's direction of travel.

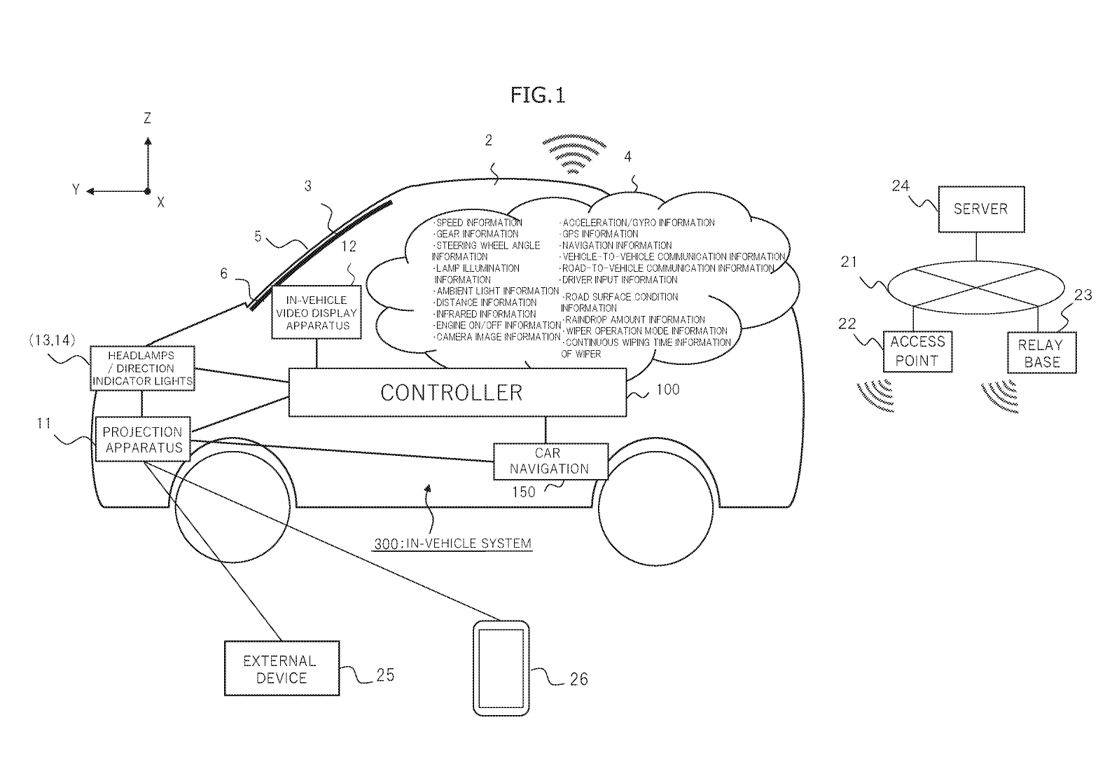

FIG. 1 is a schematic diagram showing the vehicle. As shown in FIG. 1, the vehicle 2 includes, for example, a projection apparatus 11 (information projection apparatus), an in-vehicle video display apparatus 12, a car navigation 150, headlamps 13 (i.e., headlights 13), tail lights (not shown), direction indicator lights 14, and a controller 100. Furthermore, the vehicle 2 incorporates an in-vehicle system 300 comprising these components. This in-vehicle system 300 implements an in-vehicle network, and the controller 100 be able to transmit and receive data or information with such as these components, other components described later. The in-vehicle system 300 implements, for example, CAN (Controller Area Network), in-vehicle Ethernet, LIN (Local Interconnect Network), etc.

Furthermore, the in-vehicle system 300 can communicate with the vehicle's external environment via a communication device. Examples of communication with the vehicle's external environment, it is used to direct communication methods and indirect communication methods. The direct communication method uses such as the 760 MHz band, the 5.9 GHz band, internationally as ITS (Intelligent Transport System) communication bands, for direct communication between vehicles and vehicles, roads and vehicles, and pedestrians and vehicles, in contrast, the indirect communication method uses mobile phone bands other than 5.9 GHz to communicate indirectly via mobile carrier networks. The in-vehicle system 300 can, for example, send and receive data or information with a server 24 connected to network 21 via an access point 22 or relay base 23 on network 21. It may also communicate with other vehicles, external devices 25, information terminals 26 held by pedestrians, or infrastructure such as terminals installed on the road the vehicle is traveling on. Examples of road-to-vehicle communication, it is performed receiving traffic congestion information and weather information using radio beacons or optical beacons.

Vehicle information 4, an example of data or information acquired by the in-vehicle system 300, includes in-vehicle sensor information, for example, such as speed information, gear information, steering wheel angle information, lamp illumination information, ambient light information, distance information, infrared information, engine ON/OFF information, camera image information, acceleration/gyro information, GPS information, navigation information, vehicle-to-vehicle communication information, road-to-vehicle communication information, pedestrian-to-vehicle communication information, Lidar (Light Detection and Ranging), road surface condition information, raindrop-related information, wiper-related information. Camera image information includes both in-vehicle and outside-vehicle camera image information. GPS information includes current time information and latitude and longitude information. This vehicle information can be obtained, for example, from the sensors described later.

Also, vehicle information 4 includes information input by the driver. The driver can input information using an appropriate device for information input. This device may be one pre-installed in the vehicle. This device may also be an external device connectable to the In-vehicle system 300 via wired or wireless means, as an input device, tablet, smartphone, AR (Augmented Reality) glasses, HMD (Head Mounted Display), other wearable devices, or a personal computer.

The in-vehicle system 300 can execute various controls, such as driving control and display control, using the acquired data or information.

The projection apparatus 11 projects an image light for displaying information. Note that, a specific configuration example of the projection apparatus 11 will be described later. The driver, persons around the vehicle 2 that is pedestrians walking near the vehicle, drivers and passengers of other vehicles traveling near the vehicle, etc., can see the images projected by the projection apparatus 11.

The in-vehicle video display apparatus 12 generates an image light for displaying information and projects the image light toward a predetermined display area 5 on the windshield 3. This enables the in-vehicle video display apparatus 12 to superimpose a virtual image corresponding to the displayed image onto the scenery, allowing the vehicle driver (driver's viewpoint) to see it. Note that, in this example, the image light is projected onto the display area 5 of the windshield 3, but the projection or image projector projecting the image light may also be a projection component such as a combiner. The in-vehicle video display apparatus 12 may be a known HUD (Head-Up Display) comprising, for example, a light source, a display panel forming the display image, and an image controller.

Car navigation 150 is an electronic device called a car navigation system. Car navigation 150 is a device that, for example, utilizes map information, indicate the current location by position information by GPS and the route to the destination. Car navigation 150 can utilize traffic information, such as VICS (Vehicle Information and Communication System, registered trademark), to present an efficient route to the destination.

In this example, headlights 13 are provided in a pair, left and right, at the front of the vehicle. Lamps, which are light-emitting elements, are incorporated inside the headlights 13. Direction indicator lights 14 are devices for indicating the direction to the surrounding area, when turn right or left, lane changes, etc., like the headlights 13, they are provided in a pair, left and right, at the front of the vehicle.

Controller 100 is an electronic control unit (ECU) installed within vehicle 2, as one example, includes a processing device (e.g., a central processing unit), a storage device, and an input/output device (I/O unit). The storage device can be configured using, for example, a main storage device and an auxiliary storage device. The main storage device is a work area of processing device, and the processing device stores data in the main storage device and executes data processing. Note that, the main storage device is, for example, RAM (Random Access Memory). The auxiliary storage device is a non-volatile storage device that stores data nonvolatile. The auxiliary storage device is, for example, ROM (Read-Only Memory).

Data or information is input to controller 100 via input/output devices and the in-vehicle network. Controller 100 can also control various devices connected to the in-vehicle network, via input/output devices and the in-vehicle network.

For example, vehicle information 4 and information acquired from server 24 are input to controller 100 via input/output devices. Controller 100 may then control, based on the acquired information, such as the operation of headlight 13, the operation of direction indicator lights 14, the operation of projection apparatus 11, the operation of in-vehicle video display apparatus 12, the operation of car navigation 150.

Projection apparatus 11 may be connected to various sensors mounted on vehicle 2, devices mounted on vehicle 2 (e.g., car navigation system 150), communication devices used for communication with the vehicle's exterior, and may acquire data or information. Projection apparatus 11 may then generate an image light for displaying information using the acquired data or information, and may project the image light.

Note that, the projection apparatus 11 may omit communication with the controller 100. Here, the projection apparatus 11 may acquire data or information from a configuration different from the controller 100, for example, via communication based on CAN, in-vehicle Ethernet, etc. Note that, the same can be applied to the in-vehicle video display apparatus 12.

Additionally, the controller 100 may generate video data using the acquired data or information, transmit the generated video data to the projection apparatus 11, and the projection apparatus 11 may generate an image light for displaying information based on the video data generated by the controller 100 and project the image light. Alternatively, the controller 100 may not generate video data, and instead, the image generation may generate video data and transmit the generated video data to the projection apparatus 11. Here, the controller 100 and the projection apparatus 11 may communicate based on, for example, FPD-Link III or GMSL (Gigabit Multimedia Serial Link), and the projection apparatus 11 may acquire the image data from the controller 100. Furthermore, the projection apparatus 11 performs processing on video that requires video processing, in video processing, it is performed processing relate to such as image distortion correction, color correction, brightness correction, contrast correction, and conversion (e.g., decoding). Regarding the video data, it may be stored in advance in the memory devices of the controller or projection apparatus, or it may be processed in real time without being stored in memory device. If stored in advance in the memory devices of the controller or projection apparatus, the stored video data may be sequentially changed by system updates or user operations, by wired or wireless methods. Note that, similar to the above description, this projection apparatus 11 may be connected to various sensors mounted on the vehicle, devices mounted on the vehicle 2 (e.g., car navigation 150), communication devices used for communication with the vehicle's exterior, etc., and may acquire data or information via communication based on CAN, in-vehicle Ethernet, etc. This projection apparatus 11 may generate an image light for displaying information based on the acquired information and project the image light. Note that, the same can be applied to the in-vehicle video display apparatus 12.

Additionally, controller 100 may control headlight 13 and projection apparatus 11 in coordination. For example, controller 100 may turn on headlight 13 and cause projection apparatus 11 to project image light forward of the vehicle. Furthermore, the controller 100 may, for example, turn off the headlight 13 and cause the projection apparatus 11 to generate an image of the information to be displayed and project the image light forward of the vehicle. That is, the headlight 13 and the projection apparatus 11 may perform coordinated operation via the controller 100.

On the other hand, the headlight 13 and the projection apparatus 11 may operate without going through the controller 100. For example, the headlight 13 and the projection apparatus 11 may be connected, and the operation of the headlight 13 may be controlled by the projection apparatus 11 (more specifically, the image controller of the projection apparatus 11). The projection apparatus 11 may, for example, turn on the headlight 13, generate an image of the information to be displayed, and project the image light forward of the vehicle. The projection apparatus 11 may also, for example, turn off the headlight 13, generate an image of the information to be displayed, and project the image light forward of the vehicle.

The projection apparatus 11 may be mounted, for example, at the front of the vehicle body, and the image light from projection apparatus 11 may be projected onto the road surface in front of the vehicle. The projection apparatus 11 may be mounted, for example, near the roof of vehicle body 2. The projection apparatus 11 may also be mounted, for example, on the side mirror portion, on the roof, on the side of vehicle body 2, on the bottom surface, etc. Note that, the present invention is not limited to these.

The projection apparatus 11 may be mounted in one or a plurality of units. For example, the projection apparatus 11 may be mounted in a pair at the front end of the vehicle 2. Furthermore, the projection apparatus 11 may be integrally incorporated within the headlight 13, for example. When the projection apparatus 11 is integrally incorporated within the headlight 13, the light source of the headlight 13 may also be used as the projection light source.

The projection apparatus 11 may be mounted, for example, at the rear of the vehicle body, and the image light from projection apparatus 11 may be projected onto the road surface behind the vehicle. Furthermore, the projection apparatus 11 may be mounted, for example, as a pair at the rear end of vehicle 2. Furthermore, the projection apparatus 11 may be integrally incorporated, for example, within the tail lights. When the projection apparatus 11 is integrally incorporated within the tail lights, the light source of the tail lights may also be used as the projection light source. The tail lights described above may also be brake lights or reverse lights, and subsequent mention of "tail lights" may be replaced with brake lights or reverse lights.

Furthermore, the controller 100 may control the tail lights and the projection apparatus 11 in coordination. For example, the controller 100 may true on the tail lights and cause the projection apparatus 11 to generate an image of the information to be displayed and project the image light toward the rear of the vehicle. Furthermore, controller 100 may, for example, turn off the tail lights and cause projection apparatus 11 to generate an image of the information to be displayed, project the image light toward the rear of the vehicle. That is, the tail lights and projection apparatus 11 may perform coordinated operation via controller 100.

On the other hand, the tail lights and projection apparatus 11 may operate without going through controller 100. For example, the tail lights and projection apparatus 11 may be connected, and the operation of the tail lights may be controlled by the projection apparatus 11 (specifically, the image controller of the projection apparatus 11). The projection apparatus 11 may, for example, turn on the tail lights, generate an image of the information to be displayed, and project the image light toward the rear of the vehicle. The projection apparatus 11 may also, for example, turn off the tail lights, generate an image of the information to be displayed, and project the image light toward the rear of the vehicle.

Additionally, the controller 100 may control the direction indicator lights and the projection apparatus 11 in coordination. For example, the controller 100 may turn on the direction indicator lights, cause the projection apparatus 11 to generate an image of the information to be displayed, and project the image light toward the front or rear of the vehicle's side. Furthermore, the controller 100 may, for example, turn off the direction indicator lights, cause the projection apparatus 11 to generate an image of the information to be displayed, and project the image light toward the front or rear of the vehicle's side. That is, the direction indicator lights and the projection apparatus 11 may perform coordinated operation via the controller 100. Moreover, the turning on and off of the direction indicator lights may be controlled by the driver's operation. The projection apparatus may be configured, for example, to project the image light toward the road surface on the side of the vehicle 2.

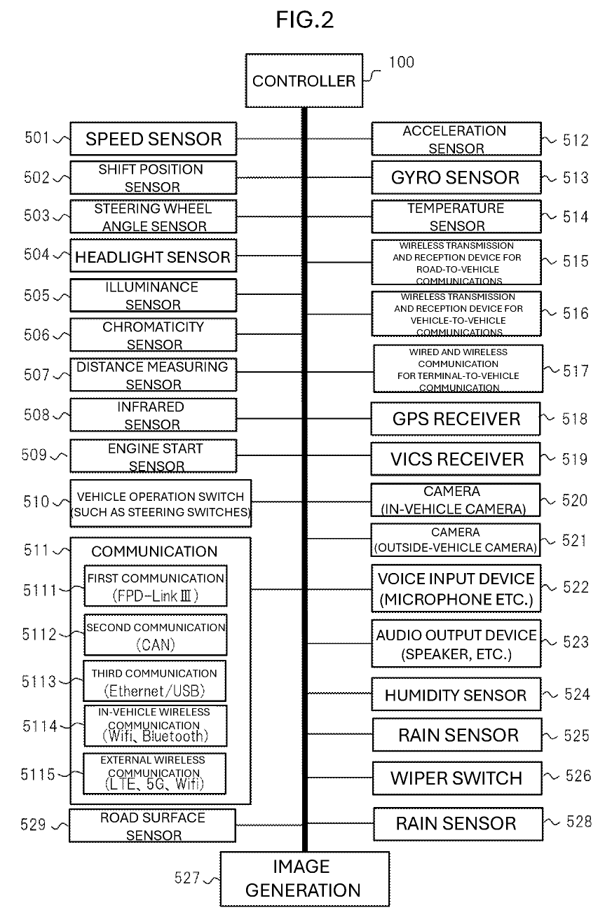

Information such as vehicle information 4 is acquired using devices such as cameras and various sensors. FIG. 2 shows an example of how the controller 100 connects to various devices. Furthermore, control units such as the projection apparatus 11, the in-vehicle video display apparatus 12, and the car navigation 150 can connect to the devices shown in FIG. 2 and directly acquire information without going through the controller 100. Regarding the various devices in FIG. 2, it is possible to delete them as appropriate, add other types of devices, or replace them with other types of devices.

The vehicle speed sensor 501 detects the speed of the vehicle 2 and is used to generate speed information, that is the detection result. The shift position sensor 502 detects the current gear and is used to generate gear information, that is the detection result. The steering wheel angle sensor 503 detects the current steering wheel angle and is used to generate steering wheel angle information, that is the detection result.

Headlight sensor 504 detects, for example, the ON/OFF state of headlight 13. Additionally, headlight sensor 504 may detect the brightness of headlight 13 when it is illuminated. The headlight sensor 504 is used to generate lamp illumination information, that is the detection results. The vehicle 2 may also be equipped with a high/low sensor that detects the state of the headlight 13 being high beam headlights or low beam headlights, and the high/low sensor is used to generate information indicating high beam headlights or low beam headlights. The vehicle 2 may also be equipped with a tail light sensor (not shown). The tail lights sensor detects, for example, the ON/OFF state of the tail lights. The tail lights sensor may also detect the brightness of the tail lights when it is illuminated. The tail lights sensor is used to generate lamp illumination information, that is the detection results. Similarly, sensors detecting the ON/OFF status and illumination brightness of brake lights, reverse lights, hazard lights, and direction indicator lights may also be provided, although not shown.

Illuminance sensor 505 and chromaticity sensor 506 detect external light around vehicle 2 and are used to generate external light information, that is the detection results. Additionally, chromaticity sensor 506 may detect the color of the road surface surrounding vehicle 2 and be used to generate projection surface color information, that is the detection results. Distance measuring sensor 507 detects the distance between vehicle 2 and external objects, or the distance between external objects themselves, and is used to generate distance information, that is the detection results. Infrared sensor 508 detects the presence and distance of objects in the vehicle's near vicinity and is used to generate infrared information, that is the detection results. Engine start sensor 509 detects the engine ON/OFF status and is used to generate ON/OFF information, that is the detection results.

Vehicle operation switch 510 refers to various switches operated by the driver or others, and is used to generate operation information such as ON/OFF status for these switches. Vehicle operation switch 510 relate to switches such as steering switches, on dashboard switches, vehicle door switches, armrest switches, and on center console switches.

The communication 511 is a configuration used for communication, including, for example, a first communication 5111, a second communication 5112, a third communication 5113, an in-vehicle wireless communication 5114, and an external wireless communication 5115.

The first communication 5111 is configured to perform communication by FPD-Link III, for example, and includes communication lines and communication devices used for FPD-Link III communication.

The second communication 5112 implements a communication protocol (CAN communication protocol) and includes communication lines and communication devices used for CAN communication.

The third communication 5113 is configured to perform communication by in-vehicle Ethernet, it implements an in-vehicle Ethernet communication protocol, and includes communication lines and communication devices used for communication by in-vehicle Ethernet. Note that, the third communication 5113 may include a USB (Universal Serial Bus) port, and the driver or others may connect devices (e.g., USB memory, devices with computer functions) to this port as appropriate. And, the third communication 5113 may perform communication by in-vehicle Ethernet, between the device connected to the port and the connection destination configuration.

The in-vehicle wireless communication 5114 is configured to communicate with in-vehicle information devices, implements communication protocols, and includes wireless devices. The in-vehicle wireless communication 5114 performs wireless communication using, for example, Wi-Fi (registered trademark) and Bluetooth (registered trademark). Note that, the in-vehicle wireless communication 5114, for example, may also perform short-range wireless communication, such as NFC (Near Field Communication).

The external wireless communication 5115 is configured to communicate with the exterior of vehicle 2, implements a communication protocol, and includes a wireless device. The external wireless communication 5115 performs wireless communication using, for example, LTE (Long Term Evolution), 5G, or Wi-Fi.

Note that, the configuration of communication 511 may be appropriately modified. Communication 511 may, for example, be configured to perform communication by LIN. Communication 511 may also, for example, be configured to perform communication by GSML.

Acceleration sensor 512 and gyro sensor 513 detect the acceleration and angular velocity of vehicle 2 and are used to generate acceleration-gyro information representing the vehicle's posture and behavior. Temperature Sensor 514 detects temperatures inside and outside the vehicle, on the road surface, etc., and is used to generate temperature information, that is the detection results.

The Wireless transmission and reception device for road-to-vehicle communications 515 generates road-to-vehicle communication information through road-to-vehicle communication between vehicle 2 and the road, signs, signals, etc. The Wireless transmission and reception device for vehicle-to-vehicle communications 516 generates vehicle-to-vehicle communication information through vehicle-to-vehicle communication between vehicle 2 and other surrounding vehicles. Wired and wireless communication for terminal-to-vehicle communication 517 is a device that acquires information by wired or wireless communication from equipment (e.g., Wi-Fi equipment) connected to the LTE network. Controller 100 or the control unit can acquire information transmitted and received over the LTE network, via the wired and wireless communication for terminal-to-vehicle communication 517.

GPS receiver 518 generates GPS information obtained by receiving GPS signals from GPS satellites. For example, by GPS receiver 518, it can acquire the current time, latitude, and longitude. VICS receiver 519 generates VICS information obtained by receiving VICS signals. Here, VICS signals include congestion information, weather information, etc., by radio beacons or optical beacons. GPS receiver 518 and VICS receiver 519 may be provided as part of a navigation system.

The in-vehicle camera 520 and the outside-vehicle camera 521 capture images inside and outside the vehicle, and are used to generate in-vehicle camera image information and outside-vehicle camera image information. Specifically, the in-vehicle camera 520 is, for example, a camera for a DMS (Driver Monitoring System) that captures the driver's posture, eye position, movements, etc. In this case, analyzing the captured images allows for the assessment of the driver's fatigue status and gaze position, etc.

Voice input device 522 receives the driver's voice and is used to generate voice information. The driver can input operation content via voice input device 522 by speaking. Audio output device 523 is a device that outputs audio processed by, for example, controller 100 or the control unit.

Humidity Sensor 524 detects humidity and is used to generate humidity information. Humidity Sensor 524 detects humidity outside vehicle 2 and on the road surface, and humidity information outside vehicle 2 may be generated. Furthermore, Humidity Sensor 524 detects humidity inside vehicle 2, and humidity information inside the vehicle may be generated.

Rain Sensor 525 detects raindrops and is used to generate rainfall information. Wiper Switch 526 detects the ON/OFF state of Wiper 6 and is used to generate Wiper 6 ON/OFF information. The direction indicator lights Switch (not shown) detects the driver's operation of the direction indicator lights and is used to generate direction indicator lights information.

The image generation 527 may generate image information based on information acquired from each sensor, or from the External device 25, or from the information terminal 26, or from the Internet, etc., may generate image information based on information acquired by the controller 100. Information other than vehicle information includes information from the external device 25 or the mobile device 26, or information from the Internet, etc. On the other hand, the image generation 527 may be omitted, in such a case, the controller 100 may be configured as the video generation function.

The rain sensor 528 detects the amount and size of raindrops. The rain sensor 528 can measure rainfall conditions by the amount of light entering the detector is decreased, by the presence of raindrops. The amount of raindrops detected by the rain sensor 528, may be used to generate related information such as the operating time of the wiper 6. Furthermore, the wiper 6's operating state may be changed in conjunction with the vehicle 2's running speed and the rain sensor 528's detection results, or it may be used to correct related information such as the wiper 6's operating time.

The road surface sensor 529 detects information regarding the road surface condition. The road surface sensor 529 may directly measure the wetness of the road surface or detect friction with the road surface. Alternatively, it may detect acceleration by the road surface condition and classify the road surface state from the acceleration waveform into states such as dry, semi-dry, wet, slush, fresh snow, compacted snow, ice, etc.

Controller 100 or the processor may, for example, transmit and receive data or information via wireless communication to acquire information necessary for driving. Controller 100 or the processor may also acquire information necessary for autonomous driving. Furthermore, controller 100 or the processor may, for example, transmit and receive data or information via wireless communication to perform data or information update processing. Controller 100 or the processor may perform updating, for example, such as various data or information (e.g., map data, data used for image processing, software, etc.), as update processing. Such technology is sometimes referred to as OTA (Over-the-Air) technology.

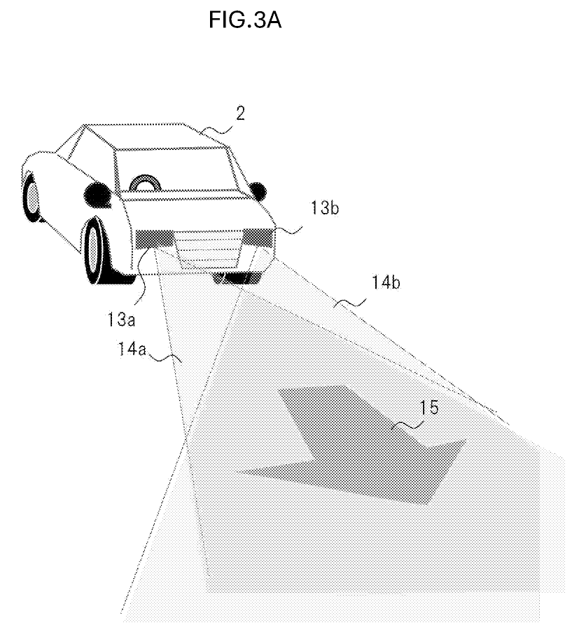

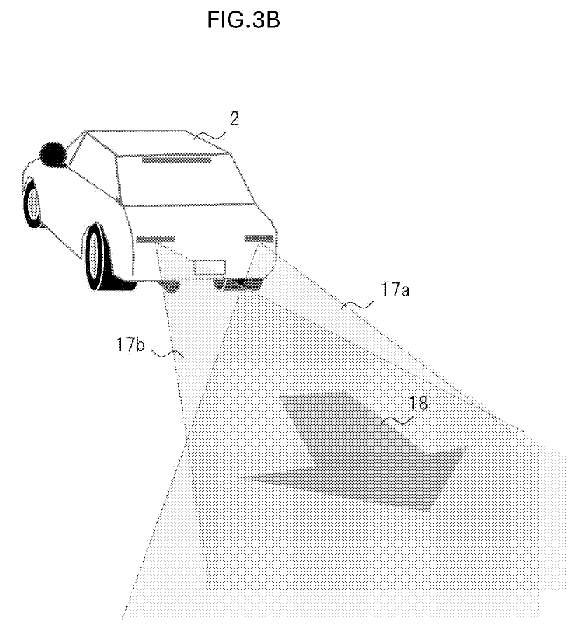

Next, referring to FIG. 3, an example of information projection by the projection apparatus will be described. As shown in FIG. 3A, image light is projected from the projection apparatus onto the road surface ahead, and in the figure, projection area 14a projected from projection apparatus 11 through the front right window section 13a of the vehicle 2, and projection area 14b projected from projection apparatus 11 through the front left window section 13b of the vehicle 2, are shown. The projected images of each projection area (14a, 14b) are combined to project an image (in this example, an arrow 15 that regarding of displaying vehicle 2 is traveling straight ahead) onto the road surface in front of vehicle 2. Note that in this example, the projection areas (14a, 14b) are divided left and right, but the projection areas may also be divided, for example, into areas near and far from the vehicle. Furthermore, image light may be projected using only one of the projection apparatus 11 installed on left and right side of the vehicle. In this example, the projection apparatus 11 is incorporated within the headlight 13, and the light source of the headlight 13 is utilized as the projection light source. However, as mentioned above, the placement of the projection apparatus 11 may be changed as appropriate. The projection apparatus 11 may have a light-emitting configuration different from that of the headlight 13, and the image light may be projected using the light emitted by this configuration.

As shown in FIG. 3B, image light is projected from the projection apparatus 11 onto the road surface behind the vehicle, in the figure, projection area 17a projected from the projection apparatus 11 on the rear right side of the vehicle and projection area 17b projected from the projection apparatus 11 on the rear left side of the vehicle, are shown. The projected images of each projection area (17a, 17b) are combined to project an image (in this example, an arrow 18 that regarding of displaying the vehicle is moving straight backward) onto the road surface behind the vehicle. Note that, in this example, the projection areas (17a, 17b) are divided left and right, but the projection areas may also be divided, for example, into areas near and far from the vehicle. Furthermore, image light may be projected using only one of the projection apparatus 11 installed on left and right side of the vehicle. In this example, the projection apparatus 11 is installed such that the light source of the tail lights can be utilized as the projection light source. However, as mentioned above, the placement of the projection apparatus 11 may be changed as appropriate. The projection apparatus 11 may have an illuminating configuration different from that of the tail lights, and the image light may be projected using the light emitted by this configuration

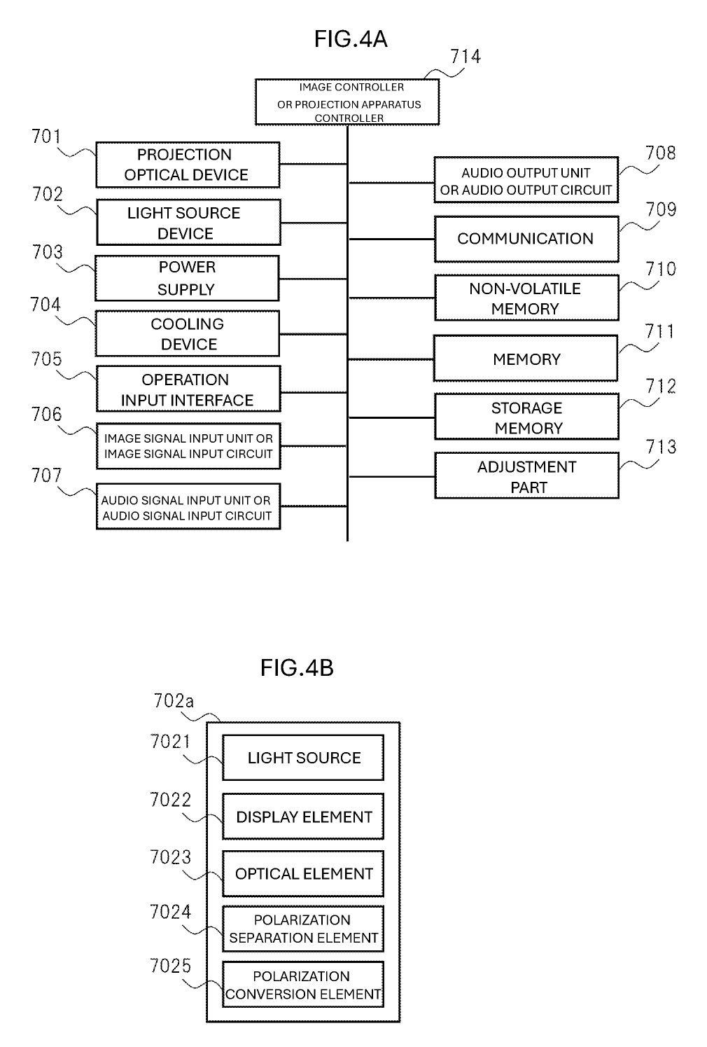

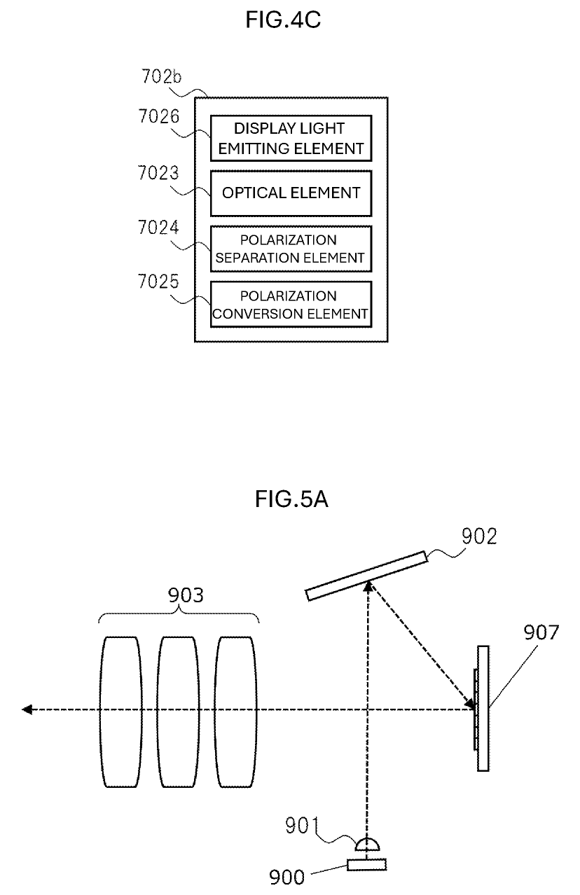

Referring to FIG. 4, an example configuration of the projection apparatus 11 is described. The projection apparatus 11 generates an image of the information to be displayed using data or information acquired, for example, via various sensors and a communication, and projects the image light. Note that, for example, data or information may be input to the projection apparatus 11 from the controller 100. Signal data, image data, etc., may be input to the projection apparatus 11 from the controller 100. The projection apparatus 11 may then process using the input information. Also, the controller 100 may be configured to control the projection apparatus 11 instead of the image controller of the projection apparatus 11. Furthermore, the image controller of the projection apparatus 11 and the controller 100 may perform processing in a divided manner, for example, the controller 100 may perform control to adjust the brightness of the headlight 13 and the brightness of the tail lights, while the image controller of the projection apparatus 11 may perform control to adjust the brightness of the projected image.

As shown in FIG. 4, the projection apparatus 11 includes a projection optical device 701 and a light source device 702. Furthermore, the projection apparatus 11 includes a power supply 703, a cooling device 704, an operation input interface 705, an image signal input unit 706 or image signal input circuit 706, an audio signal input unit 707 or audio signal input circuit 707, an audio output unit 708 or audio output circuit 708, a communication 709, a non-volatile memory 710, a memory 711, a storage memory 712, an adjustment part 713, image controller or projection apparatus controller 714. Image controller or projection apparatus controller 714 may be configured as a processing device. Image controller or projection apparatus controller 714 can control the operation of projection apparatus 11. On the other hand, when image controller 714 is not included, controller 100 can also control projection apparatus 11.

The projection optical device 701 is configured for projecting light. The projection optical device 701 includes optical components such as lenses and/or mirrors.

Light source device 702 is a device capable of generating image light. The light source device may use, for example, a high-pressure mercury lamp, a xenon lamp, an LED light source, a laser light source, etc., as the light source. Note that, the light source device may also include an optical element used for light focusing, uniformity, etc.

Power supply 703 supplies power to the light source, for example. Furthermore, power supply 703 supplies the necessary power to each of the other parts.

The cooling device 704 cools parts that become hot, such as the light source, power supply 703, or light source device 702, using air cooling and/or liquid cooling as needed.

The operation input interface 705, such as an operation button or a remote control receiver, inputs operation signals from the user. By inputting operation signals from the user, it switches the ON/OFF state of the switch (operation switch) that activates the projection apparatus 11.

The image signal input unit 706 is an interface device for acquiring image data from an external. The audio signal input unit 707 is an interface device for acquiring audio data from an external. The audio output unit 708 can, for example, perform audio output based on audio data input to the audio signal input unit 707. The audio output unit 708 may, for example, output operation sounds or error warning sounds.

The communication 709 is an interface device used for communication with the outside. The communication 709 is connected to an external information processing device (e.g., controller 100) and inputs/outputs various control signals. The communication 709 may also be connected to various sensors, communication devices installed in the vehicle 2, etc., and input/output various data or information.

Non-volatile memory 710 stores various data used, for example, in the projector function. The data stored in non-volatile memory 710 includes pre-prepared image data and video data for projecting images.

Memory 711 stores projected image data and control parameters for each part of device.

Storage memory 712 is a device that records video, images, audio, various data, etc. For example, video, images, audio, various data, etc., may be pre-recorded at the time of product shipment, and video, images, audio, various data, etc., acquired from an external device or an external server via communication 709 may be recorded. Furthermore, the image controller or projection apparatus controller 714 may acquire data or information updated from external via the communication 709, and update the recorded data or information to the new data or information. Additionally, by user selection, part or all of the recorded data or information may be updated to new data or information. The video, images, various data, etc., recorded in the storage memory 712 may be output as projected images. Audio recorded in the storage memory 712 may be output as audio from the audio output unit 708.

Adjustment part 713 is capable of adjusting the image light and includes, for example, an image adjustment part and a polarization adjustment part. The image adjustment part performs image processing on video data input in the image signal input unit, image data stored in non-volatile memory 710, or video data. This image processing includes, for example, scaling processing that performs image distortion correction, image enlargement, reduction, deformation, etc., brightness adjustment processing that changes image luminance, contrast adjustment processing that changes the image contrast curve (including adjustment of luminance gradation linearity characteristics), color correction processing that changes the image's chromaticity, and retinac processing that decomposes the image into light components (illuminant light component, reflected light component, ambient light component) and changes the weighting for each component. Note that, the image adjustment part is realized by the image controller or projection apparatus controller 714 storing data in memory 711 and executing image processing.

The polarization adjustment part adjusts the polarization degree of the projected image light. Here, the polarization degree refers to the ratio of the P-polarized light component to the S-polarized light component, which are the polarized light components contained in the light (P-polarization and S-polarization are defined relative to the projection surface). For example, the projection apparatus 11 includes a configuration capable of adjusting the polarization degree of the emitted light, such as the polarization separation element and polarization conversion element described later, and the image controller or projection apparatus controller 714 adjusts the polarization degree of the image light by controlling this configuration. Note that, the polarization control unit is realized by the image controller or projection apparatus controller 714 storing data (such as parameters used for control) in the memory 711 and controlling the aforementioned configuration. Also, multiple projection apparatus 11 with different polarization degrees may be provided and switched.

In the example of FIG. 4B, the light source device 702a comprises a light source 7021, a display element 7022, an optical element 7023, a polarization separation element 7024, and a polarization conversion element 7025. The light source 7021 generates light for image projection. Optical element 7023 is used for light focusing, uniformity, etc. Note that similar descriptions as above may be omitted. Polarization separation element 7024 is an element that separates incident light into S-polarized and P-polarized light. For example, polarization beamsplitters are used in polarization separation element 7024 to separate light by reflecting or transmitting light with a specific polarization state. The polarization conversion element 7025 is an element that converts the degree of polarization. For example, a waveplate is used in the polarization conversion element 7025, changing the polarization state by delaying the phase of the light. Here, for example, the polarization conversion element 7025 may be connected to an actuator (e.g., a motor) used to control the angle of incidence for transmission, and the adjustment part 713 or polarization adjustment part 722 in FIG. 4A, may adjust the incident light to the polarization degree according to the angle of incidence.

Furthermore, the projection apparatus 11 includes a display element and a display element driver. The display element is an element that modulates transmitted or reflected light to generate an image, such as a transmissive LCD (Liquid Crystal Display) panel, a reflective LCD panel, or a DMD (Digital Micromirror Device) (registered trademark) panel, etc., are used. The display element driver sends drive signals to the display element to generate an image on it. Display elements include configurations capable of displaying multiple images by control signals, such as DMD and LCD, as well as configurations that display only a fixed image, such as mask types.

In the example of FIG. 4C, the light source device 702b does not include a light source that serves as a backlight for the display element. In this example, the display element itself emits light. Note that, explanations similar to the above may be omitted.

The light source device 702b comprises a display light emitting element 7026, an optical element 7023, a polarization separation element 7024, and a polarization conversion element 7025. Display light emitting element 7026 is configured as a self-illuminating display, such as an LED array or an OLED (Organic Light Emitting Diode) display. Optical element 7023 is an optical system used for light focusing and uniformity. Note that, optical element 7023, polarization separation element 7024, and polarization conversion element 7025 are the same as described in FIG. 4B.

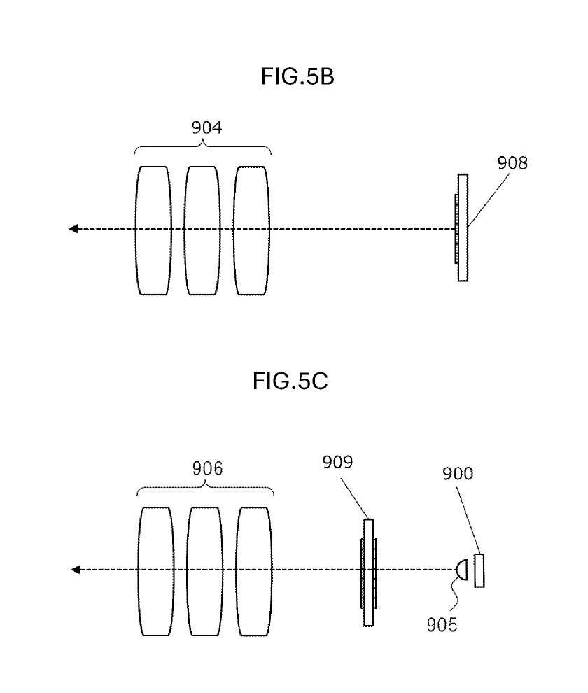

Next, referring to FIG. 5, we will explain an example of the arrangement of optical components and other parts. FIG. 5A shows an example using a reflective display element, projecting an image using a DMD method. The first optical element 901 is an optical element that collimates light generated by the light source 900, such as a collimator. The second optical element 902 is a mirror that projects the collimated light onto the display element 907. In this example, the display element 907 is configured as a DMD-type panel, and light projection is adjusted or controlled for each display pixel. The third optical element 903 is configured to project image light and is constructed using optical components such as lenses or mirrors. A reflective LCD panel may also be used as the reflective display element.

FIG. 5B shows an example that the display light emitting element 908 itself emits light to project an image. The display light emitting element 908 is configured as an LED array panel or an LED matrix panel, and the image is generated by the combination of the lighting positions and lighting colors of the LEDs on the panel. The fourth optical element 904 is configured to project the image light and is constructed using optical components such as lenses or mirrors. For the display light emitting element, an OLED display may be used instead of the above-mentioned panel.

FIG. 5C shows an example that light is transmitted through the display element 909 to display an image. The fifth optical element 905 is the same as the first optical element 901 described above. The display element 909 is, for example, a transmissive LCD panel, and an image is generated on the display element 909. The sixth optical element 906 is configured to project image light and is constructed using optical components such as lenses or mirrors. Note that, the display element 909 may be configured with a mask forming a predetermined pattern positioned on the light source side. In this case, by light passing through the mask without being obstructed by the mask which is the display element, it can display a fixed image based on the pattern formed on the mask. Additionally, the display element 909 may be configured with a lens having a predetermined pattern placed on the light source side. In this case, the display element 909 can display a fixed image based on the pattern formed on the lens. Note that, the predetermined pattern formed on the lens is formed either on the lens surface or inside the lens, and the pattern formed partially blocks light transmission, or partially transmits light. The lens used in display element 909 may be a microlens array. In that case, the pattern formed on each lens is different.

A modified example in which a light shielding plate is provided instead of the display element of FIG. 5C will be described. As an example, the light shielding plate has a window portion that transmits light rays from the light source 900. The shape of the window portion is not limited and may be, for example, a geometric shape such as a rectangle or a chevron shape, or an icon, letter, or number. The window portion may also have a shape that can be changed depending on the image to be projected. For example, a rectangular image may be changed to a chevron image based on acquired information and continuously projected. The sixth optical element 906 is configured to project light rays that have passed through the window portion of the light shielding plate onto the road surface and is configured using optical components such as a lens, a mirror, and an aperture. The sixth optical element 906 controls the length, size, and brightness of the image projected onto the road surface. Furthermore, the length, size, and brightness of the image projected onto the road surface can also be controlled by changing the shape, size, transmittance, and opening duty of the window portion of the light shielding plate. Furthermore, the image projected onto the road surface can be made to blink by repeatedly turning the light source 900 on and off.

As another modified example, a plurality of sets of light sources 900, first optical elements 901, light shielding plates, and sixth optical elements 906 are provided. Then, by using the sixth optical element 906 to project light beams transmitted through the window portions of the plurality of light shielding plates onto the road surface so that the light beams overlap, it becomes possible to project a rectangular image linearly onto the road surface. Furthermore, by using the sixth optical element 906 to separate light beams transmitted through the window portions of the plurality of light shielding plates and project the separated light beams onto the road surface, it becomes possible to project a plurality of rectangular images arranged linearly onto the road surface. Furthermore, by sequentially lighting up the plurality of light sources 900, it becomes possible to project a rectangular image sequentially lit up in a predetermined direction (e.g., a direction away from the vehicle) onto the road surface.

Note that, the light source shown in FIGS. 5A and 5C may be configured by the light source of the projection apparatus 11, but may also be the light source of the headlight 13 or the tail lights. In this case, the light source of the projection apparatus 11 may be omitted. On the other hand, the light source shown in FIGS. 5A and 5C may also be configured as a combination of the light source of the projection apparatus 11 and the light source of the headlight 13 or the tail lights. Furthermore, the light source of the projection apparatus 11 may be configured with one or multiple. Similarly, the display element corresponding to the light source may also be one or multiple.

Next, referring to FIG. 6, an example of the display area for the image seen by the driver is described. FIG. 6 shows the illumination area A1 for the high beam headlights of headlight 13, the illumination area A2 for the low beam headlights of headlight 13, and the image area A3 for the road surface image projected by the projection apparatus 11. In the upper illumination area of the high beam headlights, the high beam headlights where high positioned, is illuminated. That is, it is possible to emit high beam headlights that illuminate the distance brightly, in this illumination area. In the lower illumination area of the high beam headlights, the high beam headlights where low positioned, is illuminated, since this area overlaps with the projection area of the low beam headlights, the low beam headlights may sometimes be formed by shading part of the illumination area of headlight 13 where the high beam headlights can be projected. Furthermore, the image projection area A3 projected by the projection apparatus 11 is contained within the illumination area A2 of the low beam headlights and the illumination area where lower illumination area A1 of the high beam headlights. Therefore, the projection apparatus 11 can also project images using the low beam headlights and high beam headlights of the headlight 13, and the projection apparatus 11 may be provided separately from the headlight 13.

Referring to FIG. 7, an example of the projection areas around the vehicle is described. FIG. 7 shows a vehicle front road surface display area A11, a vehicle rear road surface display area A12, and vehicle left/right road surface display areas A13. The vehicle front road surface display area A11 is a display area formed on the road surface ahead, referenced to the position of the vehicle itself, and the projection apparatus 11 may be configured, for example, to project image light into this area to display information. The vehicle rear road surface display area A12 is a display area formed on the road surface behind the vehicle relative to the vehicle's position, and the projection apparatus 11 may be configured, for example, to project image light onto this area to display information. The vehicle left/right road surface display area A13 is a display area formed on the left and/or right road surface relative to the vehicle's position, and the projection apparatus 11 may be configured, for example, to project image light onto this area to display information. This area A13 may be made a visible area for information displayed by vehicles and persons (such as pedestrians) around the vehicle.

In the information projection of the present invention's embodiment, a processor controls the projected image and image projection, etc. The processor may function as any one of the vehicle's controller 100, the projection apparatus 11's control unit, or an external device. For example, controller 100, an external device, or a mobile terminal may control projection apparatus 11 and image projection. Furthermore, the control unit of the projection apparatus 11 may control the projected image and image projection based on vehicle information or external information, and the controller 100 and the projection apparatus 11 may share the processing. Vehicle information 4 may include information such as reverse information, steering wheel angle information, speed information, gear information, acceleration/gyro information, road surface condition information, and direction indicator light information acquired by the receiver or acquisition circuitry. The receiver may be a sensor mounted on the vehicle or may have a function of inputting/outputting information from the vehicle or externally.

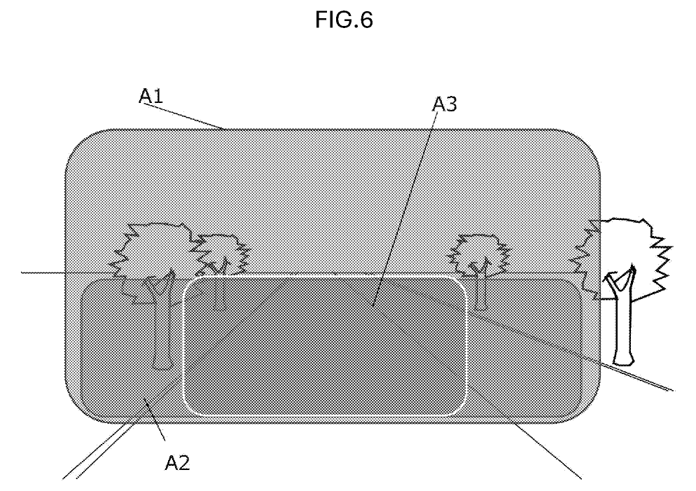

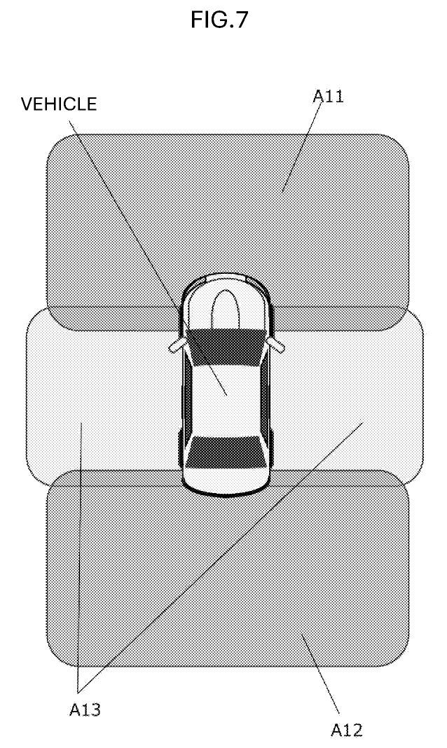

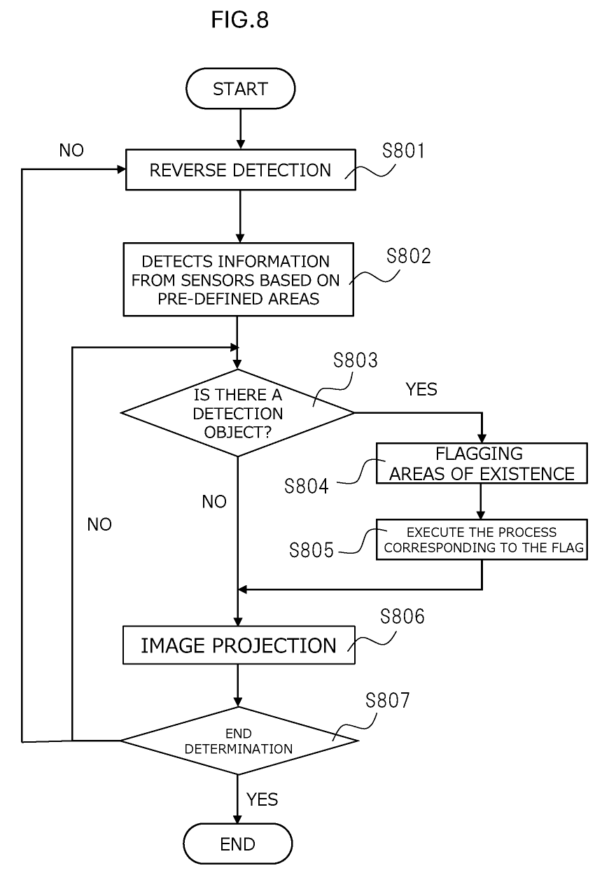

FIG. 8 illustrates an embodiment of information projection. As shown in FIG. 8, step S801 detects whether the vehicle is reversing based on information from the vehicle. If it is determined that vehicle is reversing by the information from the vehicle, the process proceeds to step S802. For example, it detects whether the vehicle is reversing, based on reverse gear on/off information from the shift position sensor 502.

Step S802 acquires information from the sensors based on a predefined projection area, when it determines in step S801 that the vehicle is reversing. In this embodiment, the projection area may be divided into an area near the vehicle and an area far from the vehicle, or it may be divided into an area near the vehicle, an area far from the vehicle, and an area outside the projectable area. Alternatively, the user may optionally select the division method as needed. The area near the vehicle may be referred to as the first area, and the area far from the vehicle as the second area. If the area outside the projectable area is set as an area, the area outside the projection area may be referred to as the third area. Information detected by the sensors includes information, such as, presence information of the detected object, the presence direction of the detected object relative to the vehicle, the distance from the vehicle body to the detected object, the relative position or relative velocity vector between the vehicle body and the detected object, the type of detected object, and surrounding environment. For example, if the detected object is an obstacle, it may include pedestrians, trees, walls, vehicles, and objects affecting the display around the own vehicle. Sensors in this embodiment may use, for example, an outside-vehicle camera 521, a distance measuring sensor 507, an infrared sensor 508, ultrasonic sensor, millimeter-wave sensor, LiDAR (Light Detection And Ranging), etc.

Step S803 determines whether a detected object (object) exists based on the information detected by the sensor in step S802. For example, if an object is detected (YES), step S803 proceeds to step S804. If an object is not detected (NO), step S803 proceeds to step S806.

Step S804 adds a mark (e.g., flag) the area where presence area of the detected object (e.g., obstacle) determined in step S803. Step S805 executes processing corresponding to the mark.

For example, it may switch the type of sensor used for image projection or the information according to the mark.

Step S806 projects an image based on the information obtained in step S803 or step S805. For example, if step S803 determines that the detection target does not exist, normal projection is performed. Based on the information obtained in step S805, the image may be projected smaller, projected with altered brightness, or not projected at all.

Step S807 is a step for determining the end of image projection. In step S807, based on the projection termination condition including vehicle information 4, it is determined whether to terminate the image projection. If it is determined in step S807 that image projection should end (YES), image projection ends. If it is determined that image projection should not end (NO), the process proceeds to step S801. Note that, the processing from step S801 to step S806 may be repeated until it is determined that image projection should end.

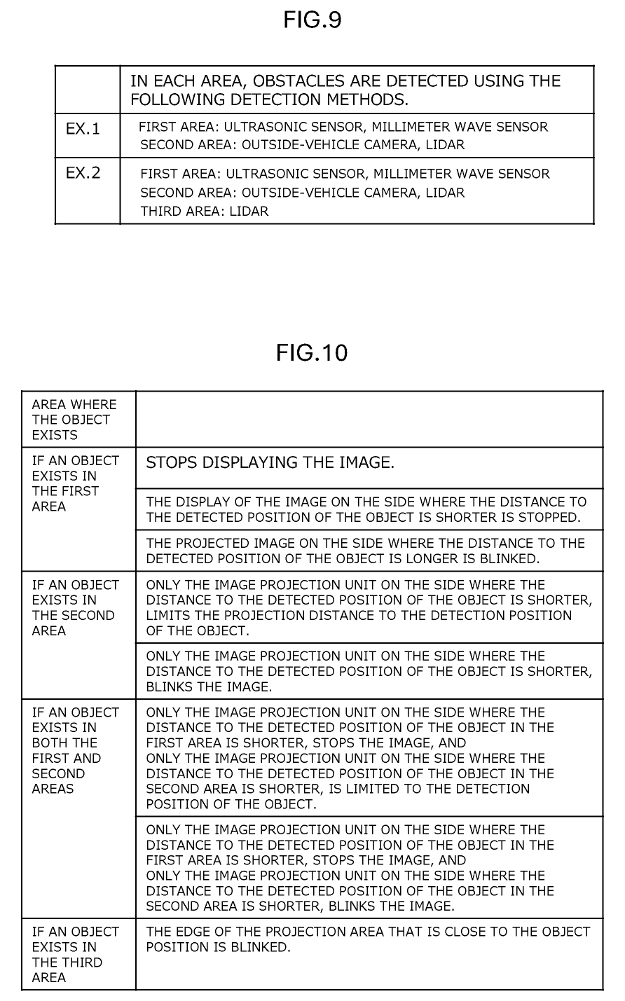

FIG. 9 is a table showing the method for detecting obstacles in each area. In this embodiment, the area behind the vehicle in example 1 is divided into a first area and a second area, while the area behind the vehicle in example 2 is divided into a first area, a second area, and a third area. Specifically, for example, the first area is set as the area where the distance in the direction away from the rear of the vehicle relative to the vehicle's front-rear direction is 1 meter or less, and the straight-line distance in the direction away from the left or right side of the vehicle relative to the vehicle's width direction is 2 meters or less. The first area is necessary to indicate the relationship between the vehicle and the projected image. If the closest distance between the image and the vehicle exceeds 1 meter, it becomes difficult to recognize that the image is projected coming from the vehicle. Furthermore, by interference between the projected image and obstacles within this area may block part or all of the image, there is a possibility that the information of projected image may not be conveyed correctly. The second area is set to an area where the distance in the direction away from the rear of the vehicle relative to the vehicle's front-rear direction is 3 meters or less, and the straight-line distance in the direction away from the left or right side of the vehicle relative to the vehicle's width direction is 2 meters or less, excluding the first area. The second area is related to the projectable area, and obstacles within this area can be made recognizable to the driver and surroundings via the image, indicating their presence, position, attributes, etc. The third area is the area in the vehicle's rear that is not covered by the first or second area. Furthermore, the range of the area is not limited to the distances described above. For example, according to vehicle height, the area may be narrowed for vehicles with low height and widened for vehicles with high height. Alternatively, the area size may be adjusted based on the presence or absence of sensors such as rear cameras, or rear view of vehicle. For example, the area may be set wider, if it is vehicle that has difficulty checking for obstacles behind.

In the area behind the vehicle, the detection ranges of multiple detection methods are overlapped, presence direction of obstacle is performed in multiple ways, simultaneously. In cases 1 and 2, either or both of ultrasonic sensors and millimeter-wave sensors are equipped, along with either or both of outside-vehicle camera and LiDAR. Each detection method also has the following differences. By ultrasonic sensor utilizes high-frequency sound waves inaudible to humans, is unaffected by color, and can detect glossy objects or transparent objects, it is possible to detect obstacle presence/absence and distance from the vehicle to the obstacle. Millimeter-wave sensor can instantly detect the position and speed of moving vehicles or people by using millimeter waves, has stable detection performance particularly in adverse weather conditions like snow or fog. LiDAR emits laser light and can measure the distance to objects and their shape based on the reflected light information. Outside-vehicle camera can capture images of the behind vehicle, by image recognition is performed using captured images, identification of obstacles is possible. When multiple detection methods are available, it is desirable to switch the detection method used for determination processing, depending on the characteristics of detection method.

In Example 1, obstacles in the first area are detected using ultrasonic sensors or millimeter-wave sensors, while obstacles in the second area are detected using the outside-vehicle camera or LiDAR. Ultrasonic and millimeter-wave sensors emit detection waves isotropically, resulting in no spatial delay and making them excellent for detecting the presence or absence of obstacles. Conversely, LiDAR scans space with laser beams and acquires spatial information in a time-division manner, potentially causing a delay in obstacle detection speed. Furthermore, obstacle detection using the outside-vehicle camera requires image recognition. Image recognition evaluates the match rate with pre-trained objects and identifies those with high match rates, but objects with low match rates may not be identified or may be misidentified as different objects. In the first area, it is located near the vehicle, so information about the presence or absence of obstacles takes priority over information about their attributes. Therefore, in this area, information from ultrasonic sensors or millimeter-wave sensors is used for detection. In the second area, the distance from the vehicle is greater, so there is a time lag for contact with a vehicle. Thus, it is desirable to utilize information other than the presence or absence of obstacles. Therefore, in this area, information from outside-vehicle cameras or LiDAR is used for detection.

The area behind the vehicle of example 2 is divided into the first area, second area, and third area, obstacles in the first area are detected using ultrasonic sensors or millimeter-wave sensors, obstacles in the second area are detected using outside-vehicle cameras or LiDAR, and obstacles in the third area are detected using LiDAR. In this example, within the third area, the pixel count at the location where objects are recorded decreases because the vehicle is sufficiently distant, raising concerns about reduced object detection accuracy when acquired by the outside-vehicle camera. In the third area, object detection for obstacles is not performed, detection is performed using LiDAR only.

FIG. 10 is a table showing image projection based on the object's presence area. If an object, such as an obstacle, exists in the first area, specifically, if the obstacle is located within the projection area of an image projector in the first area, the video display may be stopped. If the image projection is blocked by an obstacle, part or all of the road surface image may be missing, so there is a possibility that the intended image may not be displayed. In such cases, there is a concern that unintended changes in the image could provide incorrect recognition to the surroundings, so the image display may be stopped. Furthermore, as a variant example that an object existing in the first area, if an obstacle exists within the image projection area of an image projector in the first area, based on the position information of the object detected by an ultrasonic sensor, or millimeter-wave sensor, in the projection area on the side with the shorter distance from the vehicle rear to the detected object, and the projection area on the side with the longer distance from the vehicle rear to the detected object, the projected images may be different. Specifically, it stops projection to the projection area on the side with the shorter distance from the vehicle rear to the detected object, or the projection area where the detected object exists. The image projected to the projection area on the side with the longer distance from the vehicle rear to the detected object, or to the projection area where the detected object does not exist, is displayed. When multiple ultrasonic sensors or millimeter-wave sensors are installed, or by detecting the reflection angle of the detection wave, it is possible to obtain not only the distance but also the position information of the detected obstacle. If image loss caused by a detected obstacle blocking the projected image affects only one side of the images projected on both sides of the vehicle, or if image loss is likely to occur, only the image on the side unaffected by the detected obstacle may be projected. Alternatively, if there are no image loss due to obstacles in the images near the vehicle, only the images near the vehicle may be projected. Furthermore, when the image on one side is stopped due to a detected obstacle, the image on the side where the image is projected may be made to blink.

When an object exists in the second area, specifically, when an obstacle is located within the projection area of an image projector in the second area, for example, based on the position information of an object detected by LiDAR or an outside-vehicle camera, the image projected onto the projection area on the side with the shorter distance from the vehicle rear to the detected object is displayed according to the projection distance, alternatively, the image projected onto the projection area where the object detected from the vehicle rear exists is displayed according to the projection distance. In other words, the projection distance of the image projected by the image projector (image projection apparatus) on the side with the shorter distance from the vehicle rear to the detected object is limited to the distance to the detected object's position. As a modified example where the detected object exists in the second area, if the detected obstacle exists within the area of the image projected by the image projector in the second area, the image projected onto the projection area on the side with the shorter distance from the vehicle to the detected object, or onto the projection area where the object exists, may be made to blink.

When an object exists in both the first area and the second area, specifically, when the object is located within the image projection area of both the first area and the second area, for example, the image projection from the image projector on the side shorter to the object existing in the first area (or the projection area where the object exists) is stopped, and the projected image from the image projector on the side shorter to the object existing in the second area (or the projection area where the object exists) is limited to the distance to the detected object's position. Furthermore, when an object is detected simultaneously in both the first area and the second area within the image projection area on the same side of the projection apparatus relative to the vehicle, projection is controlled based on the object in the first area. As a modified example where the detected object exists in both the first area and the second area, in a situation where multiple detected objects exist, if a detected object exists in the image projection area of at least the first area and a detected object also exists in the image projection area of the second area, only the image projector on the side shorter to the detected object existing in the first area(or the area of the projected image where the object exists) stops image projection, and the projection image from the image projector on the side shorter to the detected object in the second area (or the area of the projected image where the object exists) is made to blink.

When an object exists in the third area, specifically, when an obstacle is located outside the projection area of an image projector, for example, based on the position information of an object detected by LiDAR, an image is projected onto the projection area near the detected object from the rear of the vehicle. For example, if an object detected in the third area approaches the projection area on the vehicle's left side, project a caution image onto the projection area adjacent to the third area on the vehicle's left side. Alternatively, the image projected onto the projection area adjacent to the third area where the object exists may be made to blink.

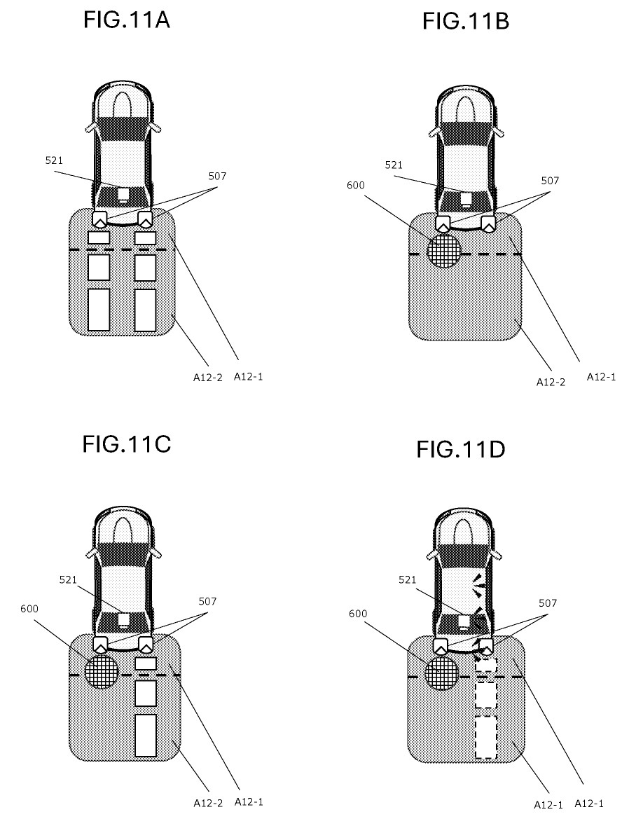

FIG. 11 shows an example of projecting an image according to an area. As shown in FIG. 11, a distance measuring sensor 507 and an outside-vehicle camera 521 are provided for rear monitoring. The distance from the vehicle to an object can be estimated through image recognition of the video acquired by the outside-vehicle camera 521. In this embodiment, the projection area is divided into a first area A12-1 and a second area A12-2. Detection of objects within the display area of the image projector projection area is performed using the distance measuring sensor 507, and estimation of distances to other distant objects is performed using the outside-vehicle camera 521. Furthermore, objects hereafter will be explained using obstacles.

FIG. 11A shows the state during normal projection when the vehicle is reversing, projecting rectangular images indicating reverse into the first area A12-1 and second area A12-2 behind the vehicle. Specifically, the rectangular images consist of multiple images. When the vehicle reverses, one rectangular image is projected onto the first area A12-1, and two rectangular images are projected onto the second area A12-2. The rectangular images can be not displayed, partially displayed, or displayed as blinking, depending on the obstacle's position. This normal projection is performed when no obstacle is detected behind the vehicle. In this example, the projected image is separated into three rectangles, but it may be displayed as a single rectangle, it may be rectangle length adjusted based on the obstacle's position, or it may be displayed by dividing it into three or more rectangles.

FIG. 11B shows an example where an obstacle exists behind the vehicle during vehicle reverse operation, illustrating the positional relationship between the vehicle and the obstacle within the projection area. As shown in FIG. 11B, obstacle 600 is located near the vehicle's left-side tail lights (image projector). In this example, obstacle 600 exists between the projection area of the image for first area A12-1 and the projection area of the image for second area A12-2. Since the presence of obstacle 600 in first area A12-1 was detected, the image projection is stopped. By stopping the projection, the image light is shielded by obstacle 600, preventing defects in the image projected onto the road surface.

FIG. 11C is diagram shows the image projection in state FIG. 11B. When obstacle 600 exists within the projection area of the image for either the first area A12-1 or the second area A12-2 on the rear left side of the vehicle, the projection apparatus on the rear right side of the vehicle, where no obstacle exists, performs normal image projection, while the projection apparatus on the left side of the vehicle does not project an image. Specifically, it detects whether obstacle 600 is present on the left or right side of the projection apparatus installed behind the vehicle. If it is located in image display unit of the image projector on the side where the obstacle 600 exists, within the first area A12-1, the image is not projected. On the other hand, the image projector on the side where obstacle 600 does not exist within the first area A12-1 may project an image.

FIG. 11D is a modified example of FIG. 11C. In this example, by the presence of obstacle 600, it may reduce the effectiveness of alerting surrounding vehicles and pedestrians, by projection from one side of the projection apparatus to be stopped and the image becomes relatively small, for the image that should normally be projected. In such cases, the image from the projection apparatus that has not stopped projection may be made to blink.

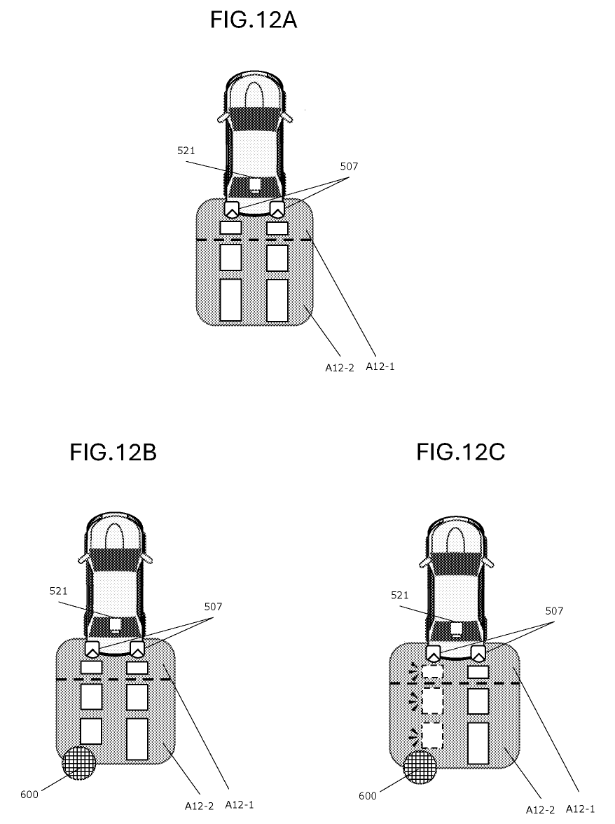

FIG. 12 shows a modified example that projects images according to the area. FIG. 12 illustrates features different from those in FIG. 11. FIG. 12A shows the normal projection state during vehicle reverse operation, projecting rectangular images indicating reverse into the first area A12-1 and the second area A12-2 behind the vehicle.

FIG. 12B shows an example of projecting an image when an obstacle 600 exists in the second area. Specifically, as shown in FIG. 12B, when the vehicle is reversing, obstacle 600 exists within the projection image area of the second area on the vehicle's left side. In such a case, since no obstacle 600 exists on the projection apparatus side at the vehicle's rear right, normal image projection is performed. The projection apparatus side at the vehicle's rear left projects the image adjusted for the distance to obstacle 600. In this example, the projection apparatus side at the rear left of the vehicle projects the projection image with reduced. That is, when obstacle 600 is located within the image projection area of the image projector in the second area A12-2, rather than the first area A12-1, the image is projected according to the distance to the location of obstacle 600.

As shown in FIG. 12C, the left side of the vehicle may blink the image. That is, by blinking the image from the projection apparatus on the side where obstacle 600 exists, the direction of the obstacle's presence can be indicated to surrounding people, vehicles, and the driver of the vehicle itself.

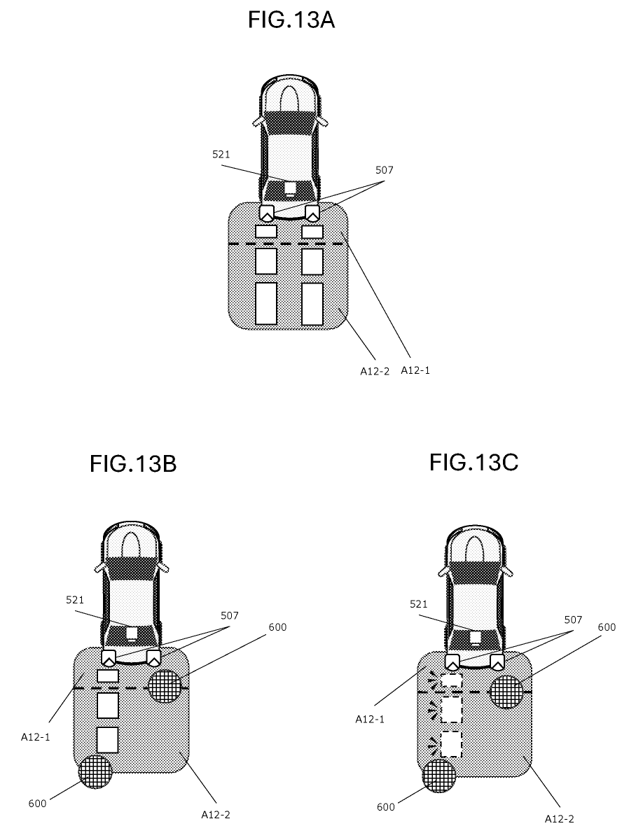

FIG. 13 illustrates an example where images are projected according to the detected obstacle area when multiple obstacles exist. FIG. 13 explains features different from FIG. 11. FIG. 13A shows the normal projection state during vehicle reversing, projecting rectangular images indicating reverse into the first area A12-1 and second area A12-2 behind the vehicle.

FIG. 13B shows an example where multiple obstacles are detected. In this example, obstacle 600 exists the vehicle's left side in the second area A12-2 and near the vehicle's right side tail lights in the first area A12-1. Specifically, obstacle 600 exists near the vehicle's right side tail lights within the image projection area of the first area A12-1 and on the vehicle's left side within the image projection area of the second area A12-2. In such cases, the projection content may be changed individually for the vehicle's rear right and rear left sides based on the detected object's position. For the vehicle's rear right side, since obstacle 600 is detected in the image projection area of the first area A12-1, the projection apparatus for the vehicle's rear right side does not project an image to prevent the projected image from being blocked by obstacle 600. Furthermore, since obstacle 600 is detected in the image projection area of the second area A12-2 at the rear left side of the vehicle, the projection apparatus at the rear left side projects an image adjusted for the distance to obstacle 600. That is, the projection apparatus at the rear left side projects an image that is shortened relative to the normal image.

FIG. 13C is a modified example of FIG. 13B. In this example, by the presence of obstacle 600, it may reduce the effectiveness of alerting surrounding vehicles and pedestrians, by projection from one side of the projection apparatus to be stopped and the image becomes relatively small, for the image that should normally be projected. In such cases, the image from the projection apparatus that has not stopped projection may be made to blink.

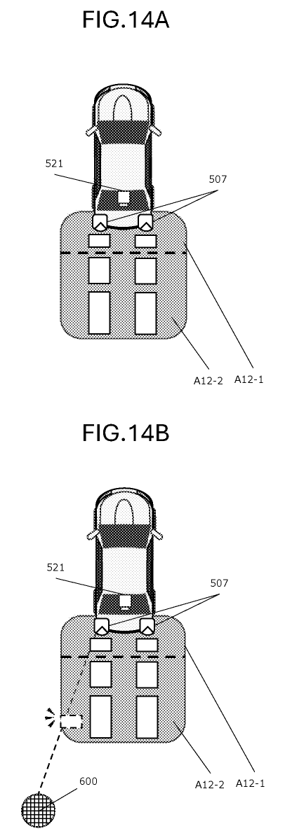

FIG. 14 shows a modified example of projecting images according to the area. FIG. 14 illustrates features different from those in FIG. 11. FIG. 14A shows the normal projection state during vehicle reverse operation, projecting a rectangular image indicating reverse into the first area A12-1 and second area A12-2 behind the vehicle. FIG. 14B shows the case where the detected obstacle 600 exists outside the image projection area, thus in the third area. In this example, when obstacle 600 exists in the third area on the rear left side of the vehicle, thus obstacle 600 is located outside the image projection area of the projection apparatus. In such cases, both the rear left and rear right projection apparatus may perform normal projection, additionally, a caution image may be projected near the outer perimeter of the projection area closest to obstacle 600. The detected position of obstacle 600 is outside the image projection area, preventing direct projection, but as shown in the figure, it displays a caution image on closest to in the area where an obstacle exists in the image projection area, can provide advance notification. Alternatively, the caution image from the projection apparatus may be made to blink.

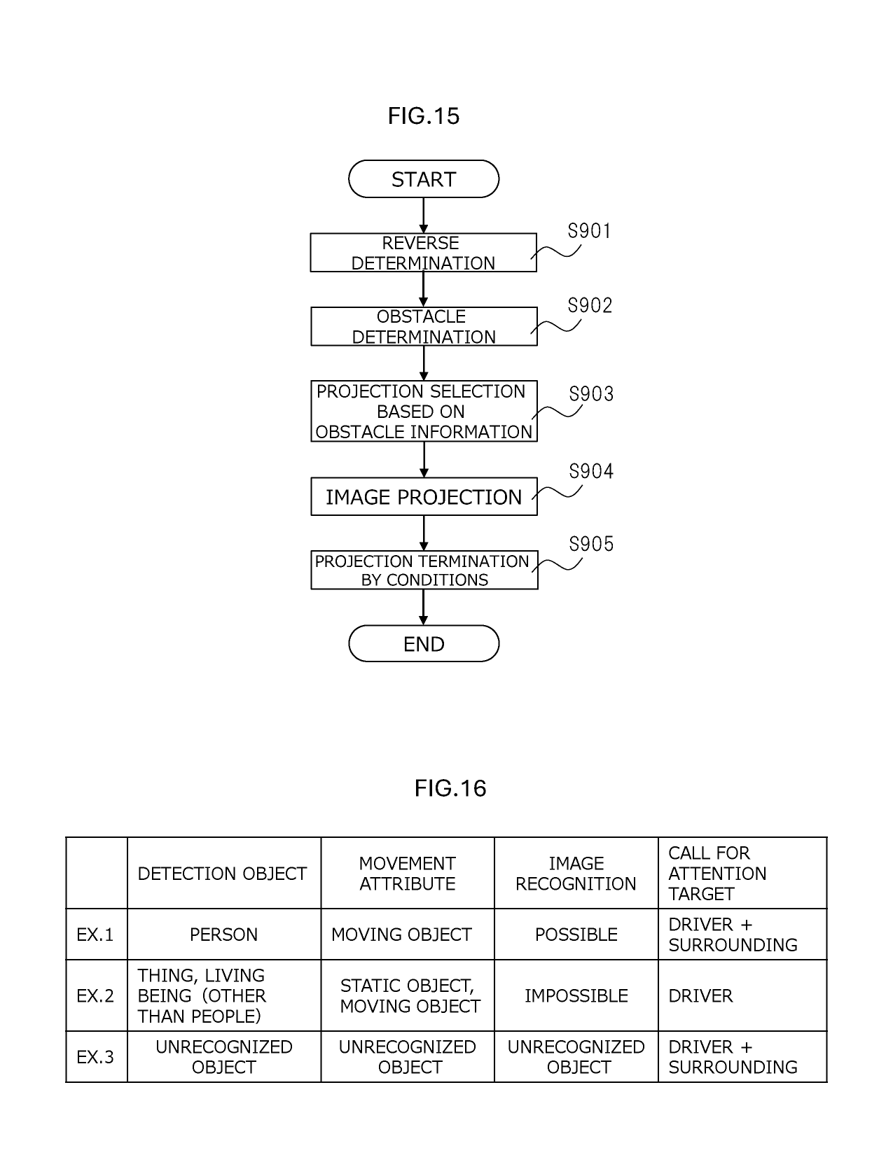

FIG. 15 shows an example of projecting information during vehicle reverse operation. As shown in FIG. 15, step S901 determines whether the vehicle is reversing based on information from the vehicle. For example, if reverse gear on detected based on the information from the vehicle, it is determined that the vehicle is reversing, if reverse gear off detected, it is determined that the vehicle is not reversing. The reverse gear information may also be obtained from the shift position sensor 502.

Step S902, after determining in step S901 that the vehicle has started a backward movement, determines whether there is an obstacle around the vehicle that may impede driving, based on external information acquired by sensors. If step S902 determines that there is an obstacle in the area behind the vehicle, it proceeds to step S903.

Step S903 selects the projection of an image displaying information about obstacles, etc., if an obstacle is determined to be present in the area behind the vehicle in step S902. The obstacle information may be obtained, for example, from the outside-vehicle camera 521, the distance measuring sensor 507, the infrared sensor 508, etc. The obstacle is included in the object or detection target. The object includes people (pedestrians), trees, walls, vehicles, and objects affecting driving around the own vehicle. For example, when detecting an obstacle within a specified distance behind the vehicle, it selects/determines a display such as an attention projection or warning projection. Furthermore, if no obstacle is detected within the specified distance behind the vehicle, normal projection is selected/determined. Next, step S904 performs the image projection selected in step S903.

Step S905 is a step for determining the end of image projection. In step S905, based on projection termination conditions including vehicle information 4, it is determined whether to terminate the image projection. For example, in step S905, if the gear is changed to the parking position, it is determined that the image projection should be terminated, and the image projection is ended.

Furthermore, in step S905, the processing from step S901 to step S904 may be repeatedly performed until it is determined to terminate the image projection.

FIG. 16 is a table showing the object. As shown in FIG. 16, the object in Example 1 is a person. The movement attribute of the person object is a moving object, meaning the object itself is capable of moving under its own volition. Furthermore, when the object is a person, since it is capable of recognizing the video projected by the vehicle and thus can be warned of danger via video, the video recognition attribute is enabled. Consequently, the person is a target for attention alerts via video display. For example, when detecting a person, attention alerts are issued to both the driver and the detected person. Therefore, a recognizable image is projected for the person, while an audio notification is issued for the driver.

The object in Example 2 is a living being other than an object or a person. The movement attribute of the object (the thing) is static object; static object means the object itself cannot move by its own volition. Furthermore, the movement attribute of the living being other than a person (the thing) is a moving object. Since objects or living beings other than people that cannot recognize the images projected by the vehicle, danger cannot be communicated via images, making the image recognition attribute impossible. In such cases, it is necessary to alert the driver, not the detected object. Therefore, when detecting an object or a living being other than a person, an audio alert is issued to the driver.

Example 3's object is an unrecognized object or an unknown object. For instance, when recognizing objects from captured images, it detects the object's presence and identifies which of the trained objects it belongs to. The identification result is evaluated based on goodness of fit that the detected object's match with the trained objects and is identified into a high confidence level class. When the captured image is unclear or the object is not present in the trained objects, the confidence level of the image recognition decreases. If the confidence level falls below a certain threshold, the detected object cannot be identified, and it may be unable to specify what the detected object is. In such cases where confidence level of image recognition is low and the object identification result is questionable, the detected object is treated as an unrecognized object and projected in a manner of similar to people. In these instances, the object is classified as an unknown object. While the movement attributes and image recognition attributes of an unknown object are those of an unrecognized object, safety considerations necessitate alerting the driver and surrounding.

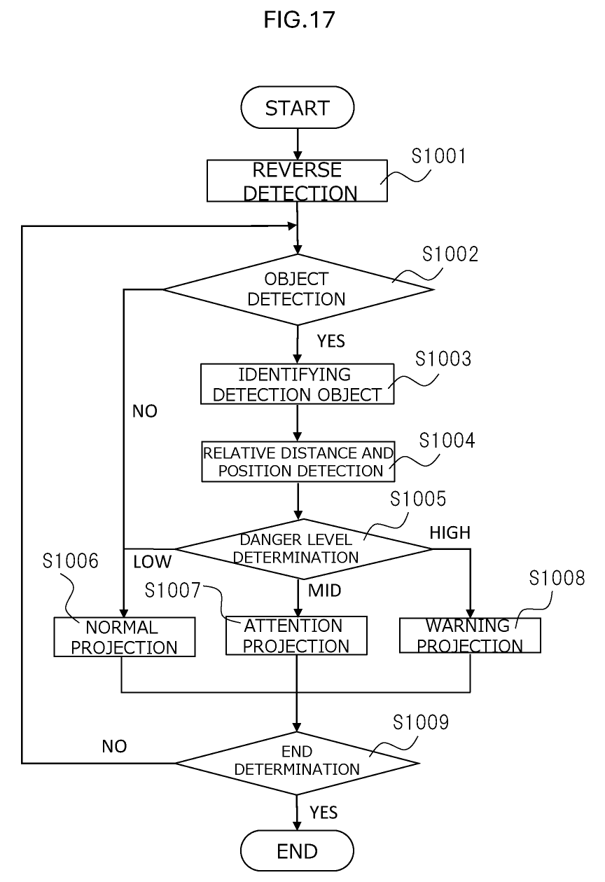

FIG. 17 shows an example of projecting images during vehicle reverse. Step S1001 detects vehicle reverse based on vehicle information from the vehicle. For example, if reverse gear on is detected, it is determined that the vehicle is reversing. If vehicle reverse is detected, proceed to step S1002. Note that the vehicle's reverse movement may be detected not only by reverse gear but also by detecting rearward movement itself based on wheel rotation direction, GPS, etc. Step S1002 detects an object (e.g., an obstacle) using a sensor. If an obstacle is detected in the area behind the vehicle (YES), proceed to step S1003. If no obstacle is detected in the area behind the vehicle (NO), proceed to step S1006.

Step S1003 is the step for identifying the object/detection target. In step S1003, the attributes of the detected obstacle are identified, such as whether it is a person or an object. After identifying the detection target, proceed to step S1004. In step S1004, the relative distance between the reversing vehicle and the detected object, or the position where the detected object exists, is detected. After detecting the relative distance between the vehicle and the detected object, proceed to step S1005. In step S1005, the danger level is determined based on the relative distance between the vehicle and the detected object detected in step S1004, or the position where the detected object exists.

If the danger level determined in step S1005 is LOW, proceed to step S1006. Here, a state where there is no risk of the object not being detected is included in danger level LOW. If the danger level determined in step S1005 is MID, proceed to step S1007. If the danger level determined in step S1005 is HIGH, proceed to step S1008. The danger levels described here will be explained later.

Step S1006 performs normal projection. Step S1007 performs attention projection. Step S1008 performs warning projection. Step S1009 is the step to terminate image projection based on conditions. If image projection is not terminated in step S1009, for example, if the vehicle continues to reverse and the detected object (such as a person) has passed through the area (no object detected), it is necessary to re-detect whether an obstacle exists in the area behind vehicle that the vehicle will be traveled next. Therefore, return to step S1002. Furthermore, when switching from a reverse operation to a forward operation, the image projection is not terminated, or an image projection related to the vehicle's forward movement is performed.

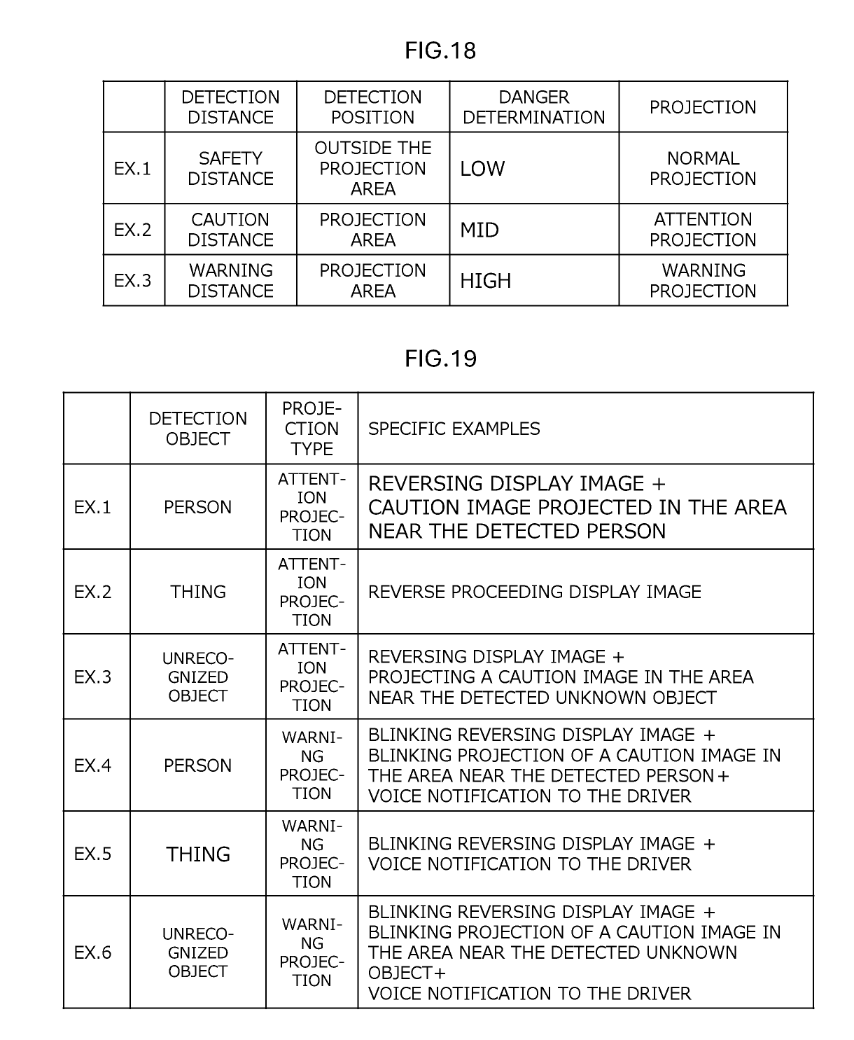

FIG. 18 shows the detection distance and danger level. The area behind the vehicle in this embodiment includes the projectable area (or projection area) and the area outside the projection area. The projectable area may be set, for example, as the area where the distance in the direction away from the rear of the vehicle relative to the vehicle's front-rear direction is less than or equal to a predetermined distance (e.g., 3 meters), and the straight-line distance in the direction away from the left or right side of the vehicle relative to the vehicle's width direction is less than or equal to a predetermined distance (e.g., 2 meters). Within the projectable area, a caution distance located farther from the vehicle and a warning distance located closer to the vehicle are set. Outside the projection area, there are a caution distance, a warning distance, and a safety distance located farther from the vehicle than the caution distance. For example, in Example 1, the distance from the vehicle to an object (e.g., an obstacle like a tree) is the safety distance. The detection position of an object within the safety distance is outside the projection area where the image is projected. If an object exists at the safety distance and outside the projection area, or if no object is detected, the danger level becomes LOW, and normal projection is performed.

In example 2, the distance from the vehicle to the object is the caution distance. The detected position of an object within the caution distance may be either inside or outside the projection area. If the object is within the caution distance in the projection area behind the vehicle, the danger level is set to MID, and attention projection is performed. On the other hand, if the object is within the caution distance outside the projection area, that is, in an area other than behind the vehicle area (e.g., on either side of the vehicle), the danger level is MID, but attention projection may not be performed.

In example 3, the distance from the vehicle to the object is the warning distance. The detected position of an object within the warning distance may be within the projection area or outside it. If the object is within the warning distance in the projection area behind the vehicle, the danger level becomes HIGH, and the image projection performs a warning projection. The safety distance, caution distance, and warning distance are preset distances.

FIG. 19 shows examples of projections based on detected objects and projection types. The object detected in example 1 is a person. In the area behind the vehicle, the distance from the vehicle to the person is determined as the caution distance, and in this example, the danger level is set to MID. In this case, since it is necessary to alert to the detected person and the vehicle's surroundings (safety distance), an attention projection is performed. For example, alongside projecting the normal image indicating vehicle reverse, an attention image is projected onto the area near the detected person. By this, the detected person to recognize the attention image displayed near, and it is possible to encourage person to stop walking or take evasive action. An audio notification to the driver may also be provided.

Next, the object detected in example 2 is an object. In the area behind the vehicle, the distance from the vehicle to the object is determined as the caution distance, and the danger level is set to MID. In this case, since it is necessary to alert to the vehicle's surroundings, an attention projection is performed. For example, a normal image indicating vehicle reverse is projected. An audio notification to the driver may also be provided.

The object detected in example 3 is an unrecognized object (unknown object). In the area behind the vehicle, the distance from the vehicle to the unknown object is determined to be within the caution distance, and the danger level is set to MID. In this case, since the detected object could potentially be a person, it is necessary to alert to the detected unknown object and the vehicle's surroundings. Therefore, an attention projection is performed. For example, it projects a normal image indicating vehicle reverse, and projects an attention image in the area near the detected unknown object. By this, if the detected unknown object is a person, the detected person recognizes the attention image displayed near, and it is possible to encourage person to stop walking or take evasive action. An audio notification to the driver may also be provided.

The object detected in example 4 is a person. In the area behind the vehicle, the distance from the vehicle to the person is determined to be within the warning distance, and the danger level is set to HIGH. In this case, since it is necessary to warn both the detected person and the driver performing the reverse drive, the projection performs a warning projection. For example, it combines a normal image indicating vehicle reverse with a blinking projection and performs the blinking projection of a caution image onto the near area of the detected person. As shown in this example, by the performing blinking projection, it has the effect of drawing the detected person's attention. Furthermore, the flickering of the rear camera image caused by the blinking projection also has the effect of drawing the gaze of driver performing the reverse drive. Additionally, in this example, the driver is notified by audio at the same time, so that the driver can be notified of the danger even if the user is unaware of it.

The object detected in example 5 is an object, such as a traffic cone. In the area behind the vehicle, the distance from the vehicle to the object is determined as the warning distance, and the danger level is set to HIGH. In this case, since it is necessary to warn the driver who is reversing, a warning projection is performed. For example, a normal image indicating vehicle reverse is projected in a blinking manner, and an audio notification is also provided to the driver.

The object detected in example 6 is an unrecognized object (unknown object). In the area behind the vehicle, the distance from the vehicle to the unknown object is determined to be within the warning distance, and the danger level is set to HIGH. In this case, the detected unknown object may potentially be a person. Since it is necessary to warn both the detected unknown object and the driver performing the reverse driving, the projection performs a warning projection. For example, a normal image indicating vehicle reverse is projected with blinking, and a caution image is projected with blinking onto the near area of the detected unknown object. Additionally, an audible notification is provided to the driver. Although not shown in the figure, when no object is detected, or when the detected object is within a safe distance, normal projection is performed to prevent unnecessary drawing.

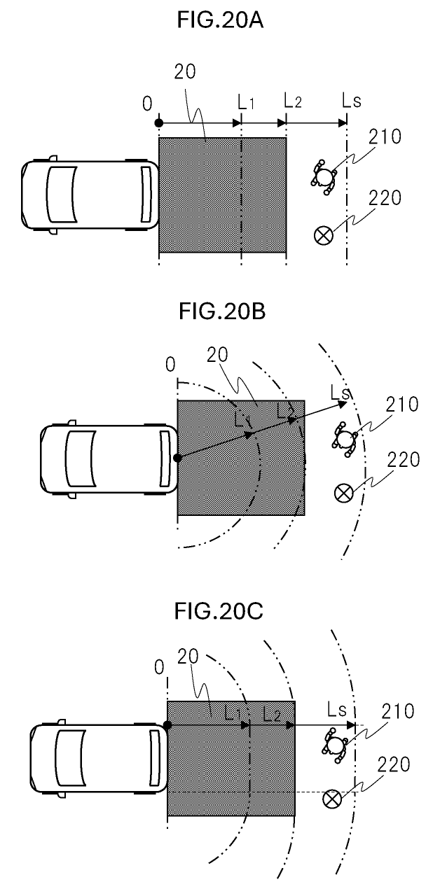

FIGS. 20A to 20C are diagrams showing the positional relationship between the vehicle and the detected object. Projection area 20 is the area where information can be projected from the vehicle to alert pedestrians, drivers, etc., specifically the area behind the vehicle in this example. Examples of detected objects shown include a person 210 and an obstacle 220 (such as a tree, wall, or traffic cone). L1, L2, and Ls are predetermined distances set for projection determination.

As shown in FIG. 20A, the distances from zero to L1, L2, and Ls define the safety area as a straight-line distance from the rear of the vehicle. The area from zero to L2 constitutes the area where images can be projected (within the projection area). The area longer than L2, or the area in the direction farther from the vehicle than L2, constitutes the area where images cannot be projected (outside the projection area). Furthermore, the distance from zero to L1 may define the warning projection area, and the distance from L1 to L2 may define the caution projection area. Since the area from L2 to Ls lies outside the projection area, both person 210 and obstacle 220 in FIG. 20A exist outside the vehicle's projection area 20.

As shown in FIG. 20B, the distances from the center of the circle behind the vehicle in the vehicle's width direction to L1, L2, and Ls define the safety area using circles centered at the rear center of the vehicle. This allows consideration of the difference in danger levels between directly behind the vehicle and diagonally behind the vehicle. The area up to radius L2 becomes the area where images can be projected (within the projection area), while the area with a radius larger than L2 (e.g., the area between radius L2 and radius Ls) becomes the area where images cannot be projected (outside the projection area). Furthermore, the area up to radius L1 may be set as the warning projection area, and the area from radius L1 to radius L2 may be set as the caution projection area. Since the area from radius L2 to radius Ls is outside the projection area, person 210 and obstacle 220 in FIG. 20B exist outside the vehicle's projection area 20.

As shown in FIG. 20C, L1, L2, and Ls define the portion corresponding to the vehicle width as a straight-line distance, while the portion outside the vehicle width is defined as a concentric circle from the vehicle edge. By combining a straight-line area and an arc area in this manner, a more precise area setting becomes possible. In this example, the portion corresponding to the vehicle width is set by straight-line distance, but the portion corresponding to the projection area width may also be set by straight-line distance. Similar to FIGS. 20A and 20B, person 210 and obstacle 220 in FIG. 20C exist outside the vehicle's projection area 20.

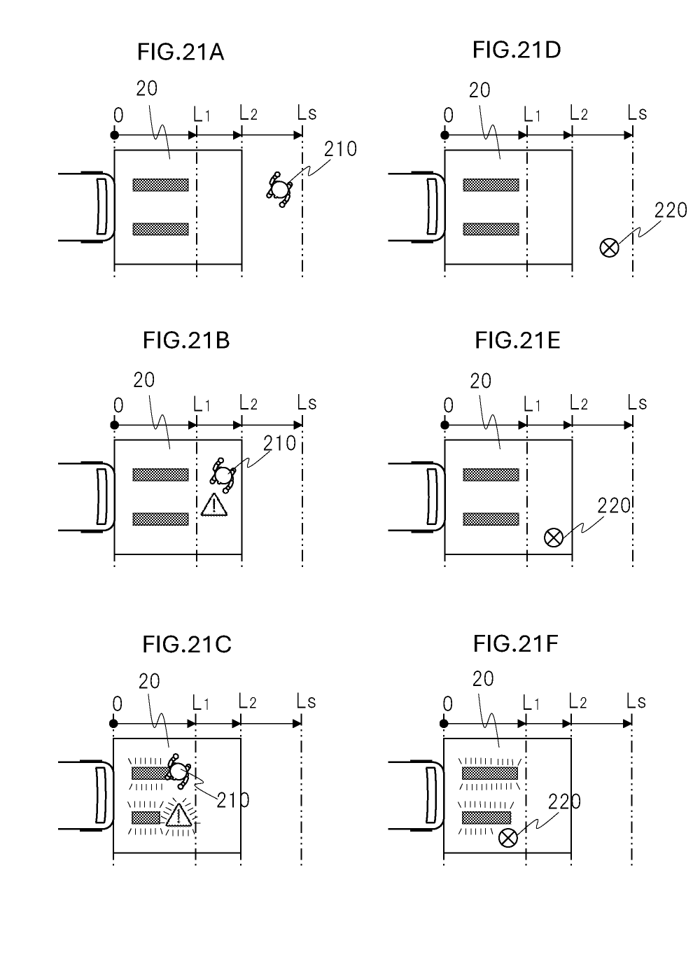

FIGS. 21A to 21F illustrate images projected according to the object. FIGS. 21A, 21B, and 21C show examples where the detected object is a person. FIGS. 21D, 21Eand 21F, show examples where the detected object is a thing. FIG. 21A shows an example where it detects a person 210 via a sensor while the vehicle is reversing, and the detected person 210 is located in an area outside the projection area 20. In such a case, the projection apparatus (or image projector) detects the vehicle's reverse gear and performs normal projection, for example, projecting a rectangular shape normal image to the left and right rear of the vehicle. Additionally, the vehicle driver may be notified by voice with a message such as "Person exists outside projection area."

FIG. 21B shows an example where, when the vehicle is reversing, a person 210 detected by the sensor is located within the area inside the projection area 20 and within the caution distance area. Alternatively, within the area inside the vehicle's projection area 20, the distance from the vehicle to person 210 is greater than the warning distance, and the danger level is set to MID. In this case, since it is necessary to alert to the detected person 210, the projection apparatus performs an attention projection. For example, it projects a rectangular shape normal image to the left and right rear of the vehicle, and simultaneously projects a caution image onto the near area of the detected person 210. At this time, the caution image is projected in a visible direction, such as toward the front foot area of the detected person 210. Additionally, the driver may be notified audibly with a message such as "Person exists in projection area."

FIG. 21C shows that when the vehicle is reversing, the person 210 detected by the sensor is located within the inner area of the projection area 20 and within the warning distance area. Alternatively, the distance from the vehicle to person 210 is within the warning area, and the danger level is set to HIGH. In this case, since a warning must be provided for the detected person 210, the projection apparatus performs a warning projection. For example, it performs blink projection of a rectangular shape normal image to the left and right rear of the vehicle and performs blink projection of a caution image onto the area of near the detected person 210. It may also notify the driver audibly with a message such as " There is a person within the danger distance from the vehicle." In FIGS. 21A, 21B, and 21C, as the vehicle reverses and the distance from the vehicle to person 210 decreases, the projection apparatus changes from normal projection to attention projection and then to warning projection.

FIG. 21D shows an example where, during vehicle reverse operation, a sensor detects an obstacle 220, and the detected obstacle 220 is located in an area outside the projection area 20. In such a case, the projection apparatus performs normal projection, for example, projecting a normal image of rectangular shape to the left and right rear of the vehicle. Additionally, the vehicle driver may be notified by voice with a message such as "Object exists outside projection area."

In FIG. 21E, when the vehicle is reversing, the obstacle 220 detected by the sensor is located within the area inside the projection area 20 and within the caution distance area. Alternatively, within the area inside the vehicle's projection area 20, the distance from the vehicle to the obstacle 220 is greater than the warning distance, and the danger level is set to MID. In this case, the projection apparatus performs an attention projection. For example, it projects a rectangular-shaped normal image to the left and right rear of the vehicle. It may also notify the driver audibly with a message such as "Object within projection area."

FIG. 21F shows an example where, when the vehicle is reversing, an obstacle 220 detected by the sensor is located within the projection area 20, specifically within the warning distance area. Alternatively, the distance from the vehicle to the obstacle 22 is the warning area, and the danger level is set to HIGH. In this case, the projection apparatus performs a warning projection. For example, it blinks and projects a rectangular shape of normal image to the left and right rear of the vehicle. Furthermore, it may be made asymmetrical relative to the length of the rectangular shape image projected to rear of the vehicle on the side where obstacle 220 exists, and the length of the rectangular shape image on the side where obstacle 220 does not exist, also, it may be made brighter and made to blink. By these changes in visual information, such as the rear camera image, a driver who has not noticed the presence of obstacle 220 can be aware existence of obstacle 220. Furthermore, the driver may be notified audibly, such as with "There is an object in the danger distance area from the vehicle." In FIGS. 21D, 21E, and 21F, as the vehicle reverses and the distance from the vehicle to obstacle 220 decreases, the projection apparatus changes from normal projection to attention projection and then to warning projection.

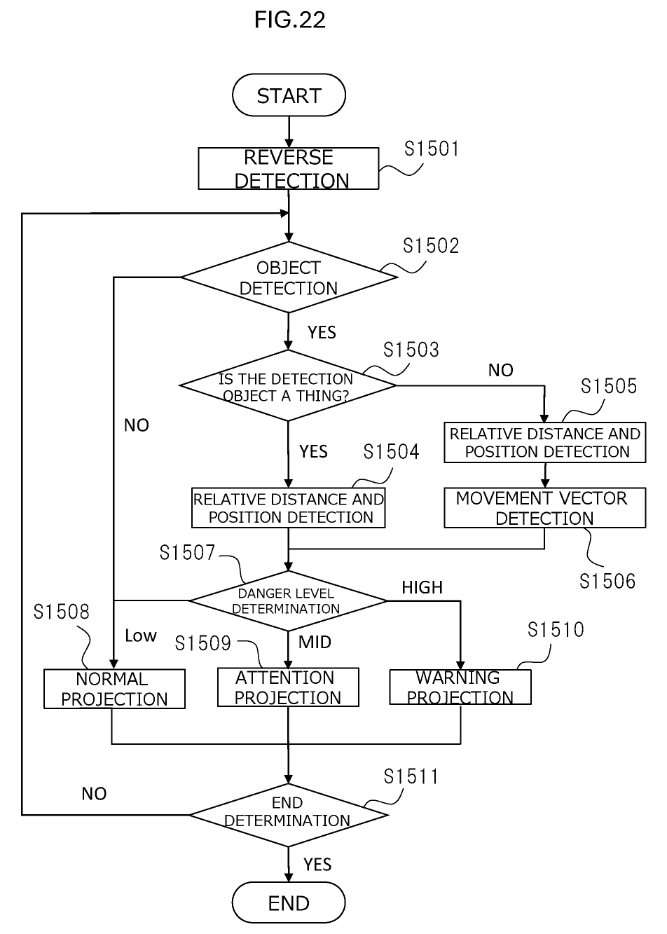

FIG. 22 shows an example of projecting an image during vehicle reverse. Step S1501 detects that the vehicle is reversing based on information from the vehicle. For example, if reverse gear on is detected, it is determined that the vehicle is reversing. If vehicle reverse is detected, proceed to step S1502.

Step S1502 detects obstacles in the area behind the vehicle using sensors. If an obstacle is detected in the area behind the vehicle (YES), proceed to step S1503. If no obstacle is detected in the area behind the vehicle (NO), proceed to step S1508.

Step S1503 determines whether the detected object is a thing. If the object is a thing (YES) in step S1503, proceed to step S1504. If the object is not a thing (NO), proceed to step S1505.

In step S1504, detect the relative distance between the vehicle reversing and the detected object, or the position of the detected object. Acquire the relative distance information between the vehicle and the detected object, or the position information, and proceed to step S1507.

In step S1505, the relative distance between the vehicle reversing and the detected object, or the position of the detected object, is detected, and the process proceeds to step S1506. Next, in step S1506, the movement vector of the detected object is detected, and the process proceeds to step S1507. Here, as the movement vector, it can be identified the direction and speed of movement relative to the vehicle by analyzing information acquired, for example, by a camera or LiDAR between frames. For example, if a detected object (e.g., a person) is moving, the danger level changes based on whether it is moving toward or away from the vehicle. Furthermore, by the magnitude of the movement vector, as it changes whether contact with the vehicle will occur, the danger level also changes.

Step S1507 determines the danger level based on the information detected in Step S1504, or in Steps S1505 and S1506. In step S1507, if the danger level determined in step S1507 is LOW, proceed to step S1508. No danger level is included in danger level LOW. If the danger level determined in step S1507 is MID, proceed to step S1509. If the danger level determined in step S1507 is HIGH, proceed to step S1510.

Step S1508 performs normal projection, and step S1509 performs attention projection. Step S1510 performs warning projection. Step S1511 is the step for determining the termination of image projection based on conditions. If image projection is not terminated in step S1511, for example, if an object such as a person is no longer detected as it passes through the area within a predetermined time, it is necessary to re-detect whether there is an obstacle in the projection area to be traveled next, so the process returns to step S1502.

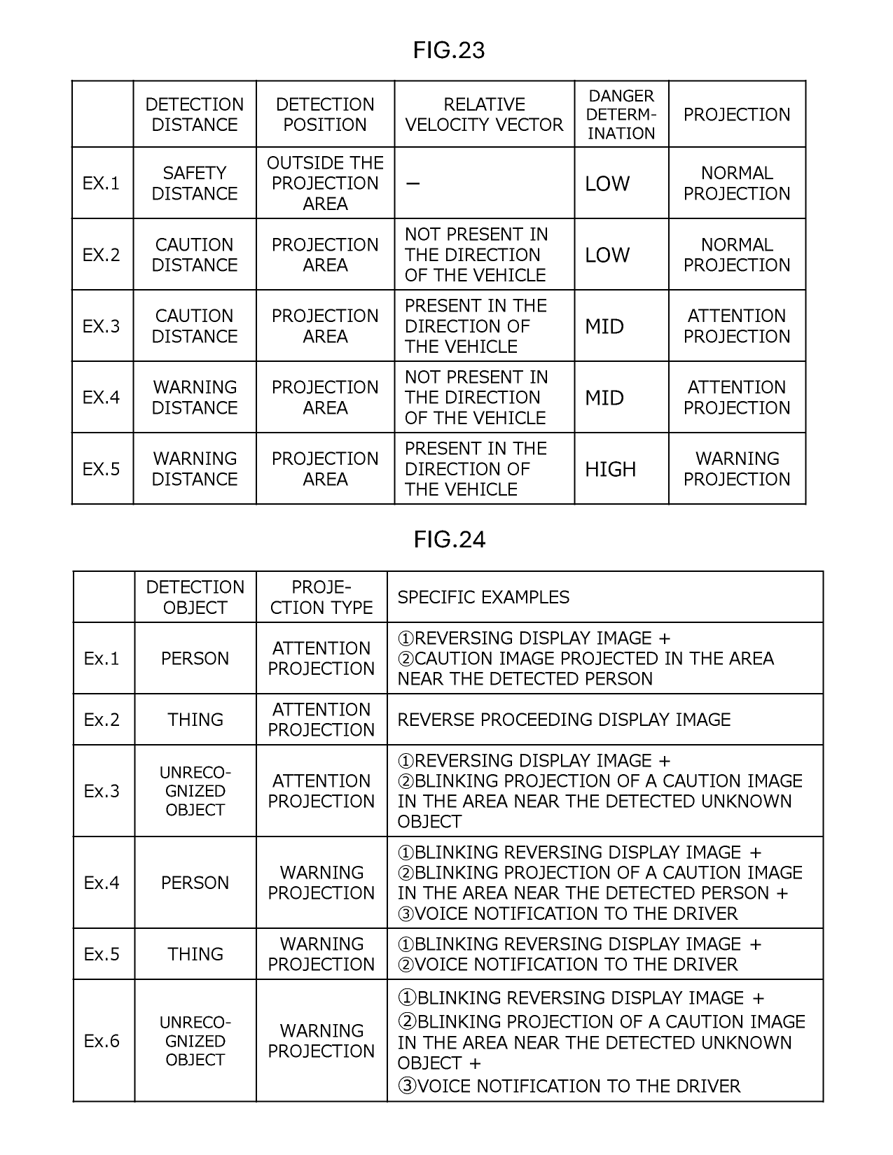

FIG. 23 shows a table indicating the danger level when the detected object is a person or an unrecognized object. The danger level when the detected object is a thing is shown in FIG. 18. As shown in FIG. 23, in example 1, the distance from the vehicle to the detected object is within the safe distance. Detected position of the object within the safe distance is outside the projection area of the image. Therefore, the danger level is set to LOW, and the projection apparatus performs normal projection.

In example 2, the distance from the vehicle to the detected object is within the caution distance. The detected position of the object within the caution distance is within the image projection area. Furthermore, this example shows that the vehicle does not exist on the extension line of the relative velocity vector of the detected object with respect to the vehicle. Under these conditions, even if the vehicle and the detected object move, they will not collide. In such a case, the danger level is set to LOW, and the projection apparatus performs normal projection.

In example 3, the distance from the vehicle to the detected object is within the caution distance. The detected object's position within the caution distance is within the image projection area. Furthermore, this is an example where the vehicle exists along the extension line, for the detected object's relative velocity vector with respect to the vehicle. Under these conditions, if the vehicle and the detected object each move, there is a high possibility of contact between them. In such a case, the danger level is set to MID, and the projection apparatus performs attention projection.

In example 4 of FIG. 23, the distance from the vehicle to the object is within the warning distance. The detected position of the object within the warning distance is within the image's projection area. Furthermore, this example shows that the vehicle does not exist along the extension line of the relative velocity vector of the detected object relative to the vehicle. Under these conditions, even if the vehicle and the detected object move, they will not collide. In such cases, the danger level is set to MID, and an attention projection is performed.

In example 5, the distance from the vehicle to the object is within the warning distance. The detected position of the object within the warning distance is within the image projection area. Furthermore, regarding the relative velocity vector of the detected object relative to the vehicle, this is an example where the vehicle exists on the extension line. Under these conditions, if the vehicle and the detected object each move, there is a high possibility of contact between them. In such cases, the danger level is set to HIGH, and the projection apparatus performs a warning projection. The safety distance, caution distance, and warning distance are pre-set distances.

FIG. 24 shows an example of changing the projected image based on the detected object. In Example 1, the detected object is a person. The distance from the vehicle to the detected person is determined as the caution distance. Since the detected person is moving toward the vehicle, the danger level is set to MID in this example. In this case, since it is necessary to alert to the detected person and the vehicle's surroundings (safety distance), the projection apparatus performs attention projection. For example, it projects a caution image onto the area of near the detected person, combined with the projection of the normal image indicating vehicle reverse.

The detected object in Example 2 is a thing. The distance from the vehicle to the detected object is determined as the caution distance, and in this example, the danger level is set to MID. In this case, an attention projection is performed. For example, a normal image indicating vehicle reverse is projected. Additionally, the driver may be notified audibly.

The detected object in example 3 is an Unrecognized object (Unknown object). The distance from the vehicle to the detected unknown object is determined to be within the caution distance. The detected unknown object is moving toward the vehicle, and in this example, the danger level is set to MID. In this case, since the detected object could potentially be a person, it is necessary to alert to the detected unknown object and the vehicle's surroundings. Therefore, the projection apparatus performs an attention projection. For example, a normal image indicating vehicle reverse is projected, and a caution image is projected onto the near area of the detected unknown object. Thereby, if the detected unknown object is a person, by recognizing the caution image displayed near, prompting them to stop walking or take evasive action. An audible notification to the driver may also be provided.

The detected object in example 4 is a person. The distance from the vehicle to the detected person is determined as the warning distance. The detected person is moving toward the vehicle within the vehicle proximity area of within the projection area, and in this example, the danger level is set to HIGH. In this case, it is necessary to warn both the detected person and the driver performing a reverse operation, so the projection apparatus performs a warning projection. For example, in conjunction with the blinking projection of the normal image indicating vehicle reverse, it performs blinking projection of a caution image onto the area near the detected person. As in this example, by performing a blinking projection, it has the effect of attracting the attention of the detected person. Furthermore, via the flicker in the rear camera image caused by the blinking projection, it has also the effect of drawing the driver's gaze. Additionally, in this example, by performing audio notification to the driver simultaneously, it can know of danger even if the user is unaware.

The detected object in example 5 is a thing, such as a traffic cone. The distance from the vehicle to the detected object is determined as the warning distance. The detected object exists within the vehicle proximity area within the projection area, and the danger level is set to HIGH, in this example. In this case, the projection apparatus performs a warning projection. For example, it performs blink projection of a normal image indicating vehicle reverse and simultaneously provides an audible notification to the driver.

The detected object in example 6 is an unrecognized object (Unknown object). The distance from the vehicle to the detected unknown object is determined to be within the warning distance. The unknown object is located within the vehicle's proximity area in the projection area and is moving toward the vehicle. In this example, the danger level is set to HIGH. In this case, since it is necessary to warn the detected unknown object and the driver performing the reverse operation, the projection apparatus performs a warning projection. For example, it performs blink projection of the normal image indicating vehicle reverse and performs blink projection of a caution image onto the area of near the detected unknown object. Additionally, an audible notification is provided to the driver. Although not shown in the figure, if no object is detected, or if the detected object is at a safe distance, normal projection is performed to prevent unnecessary attention.

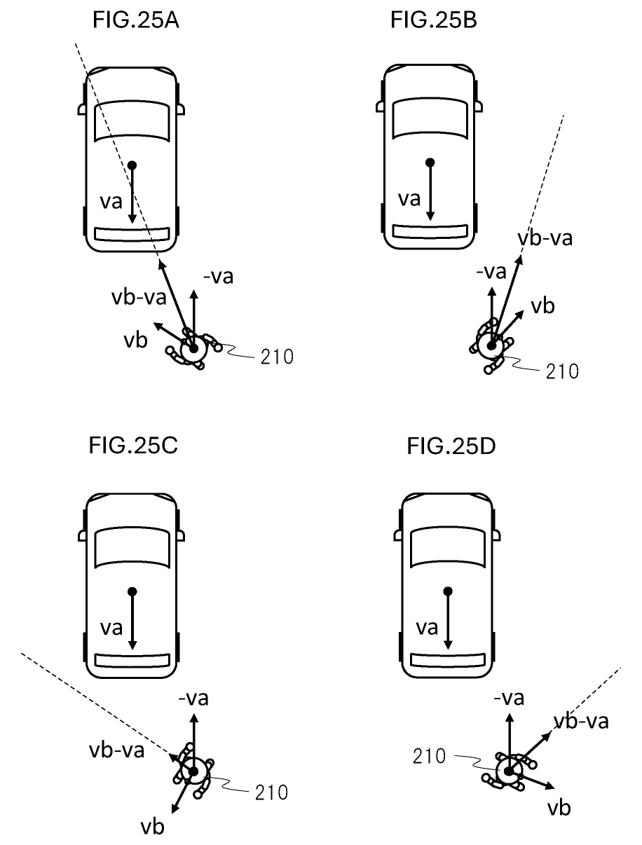

FIGS. 25A to 25D is diagram, as examples of detected objects, showing the movement direction and speed of a person and a vehicle. In FIGS. 25A to 25D, it explains using the person 210 that is object. When the vehicle's velocity vector is denoted as va and the person's velocity vector as vb, to account for the relative motion between person 210 and the vehicle, by the vehicle's velocity vector va is assigned to person 210 as a velocity vector in the opposite direction, it allows consideration solely of person 210's movement. The vector (vb - va), obtained by adding the person's velocity vector -va and the velocity vector vb, represents the relative velocity vector between the vehicle and person 210. If movement continues along the extension line of this relative velocity vector while the vehicle is present, the two will collide.

Referring to FIGS. 25A through 25D, it explains that the danger state changes dynamically in response to changes in the behavior of the vehicle and the detected person 210. In FIG. 25A, the relative velocity vector between the vehicle and person 210 points toward the vehicle, indicating a very high risk of collision, that is, the state in FIG. 25A represents the highest collision risk. In FIGS. 25B through 25D, the current risk has not yet increased significantly. However, in FIG. 25C, if the vehicle's reverse speed increases, there is a risk of collision. Furthermore, in FIGS. 25B and 25D, while the current risk is not high, caution is required if the vehicle's reverse direction changes or if the person 210's movement direction changes. In cases of FIG. 25A and FIG. 25C, the projection apparatus changes from normal projection to attention projection or warning projection depending on the distance between the vehicle and the detected person 210. In the cases of FIGS. 25B and 25D, if the vehicle's reversing direction changes to the direction where the detected person 210 exists, the projection apparatus changes to attention projection or warning projection depending on the distance between the vehicle and the detected person 210. In other words, depending on the movement direction and speed of the detected object and the vehicle, the projection apparatus performs normal projection, attention projection, or warning projection.

Note that, the present invention is not limited to the aforementioned embodiments and includes various modifications and equivalent configurations within the scope of the appended claims. For example, the aforementioned embodiments are described in detail to clearly explain the present invention and are not necessarily limited to having all the described configurations. Furthermore, for example, additions, deletions, or replacements of other configurations may be made to parts of the configuration of the embodiments.

Furthermore, using the technology of the above embodiments enables the appropriate display of necessary information, such as images for the driver or images for persons around the vehicle. This provides an information projection apparatus that contributes to safe driving. Consequently, it can help reduce traffic accidents. Moreover, it enables a contribution to 3: "Good Health and Well-Being." of Sustainable Development Goals (SDGs) advocated by the United Nations.

What is claimed is:

1. An information projection apparatus mounted on a vehicle and projecting images onto a road surface, comprising:
a receiver for acquiring information related to the vehicle; and
an image projector for projecting images,
wherein when the vehicle is reversing, the area behind the vehicle is divided into a plurality of areas,
the information projection apparatus acquires detection information relating to obstacles around the vehicle using the receiver, and
projects an image based on area information in which the detected object exists.

2. The information projection apparatus according to claim 1,
wherein the area behind the vehicle comprises a first area and a second area,
the first area is a near area of the vehicle and the second area is a far area of the vehicle,
the image is not projected when the object exists within the projection area of the image projector in the first area.

3. The information projection apparatus according to claim 1,
wherein the area behind the vehicle comprises a first area and a second area,
the first area is a near area of the vehicle and the second area is a far area of the vehicle,
when the object exists within the projection area of the image projector in the second area, the image is projected according to the distance from the vehicle to the object.

4. The information projection apparatus according to claim 3,
wherein, in the projection area of the second area, the projection of images onto the side where the object exists and onto the side where the object does not exist, are different.

5. The information projection apparatus according to claim 4,
wherein the information projection apparatus performs
blinking projection of the image.

6. The information projection apparatus according to claim 2 or claim 3,
wherein the area behind the vehicle further includes a third area,
the third area is outside the projection area of the image projector, and
when the object exists in the third area, a caution image is projected onto the first area or the second area closer to the object.

7. The information projection apparatus according to claim 1
wherein the receiver acquires multiple obstacle detection information around the vehicle,
the information projection apparatus selects information to use from the multiple obstacle detection information based on information about the area where the obstacle exists, and projects the image based on the selected information.

8. An information projection apparatus mounted on a vehicle and projecting images onto a road surface, comprising:
a receiver for acquiring information related to the vehicle; and
an image projector for projecting images,
wherein when the vehicle is reversing, based on position information of an object existing in the area behind the vehicle acquired by the receiver, the image projector performs either normal projection, attention projection, or warning projection.

9. The information projection apparatus according to claim 8,
wherein the area behind the vehicle comprises a projectable area and an area outside the projection area,
when the object is located outside the projection area and does not exist behind the vehicle, the image projector performs the normal projection.

10. The information projection apparatus according to claim 8,
wherein the area behind the vehicle comprises a projectable area and an area outside the projection area,
a caution distance and a warning distance are set within the projectable area, and the caution distance being farther from the vehicle than the warning distance,
when the object is within the caution distance and exists behind the vehicle, the image projector performs the attention projection.

11. The information projection apparatus according to claim 10,
wherein when the object is within the warning distance and exists behind the vehicle, the image projector performs the warning projection.

12. The information projection apparatus according to claim 10,
wherein when the object is a person, the image projector projects a caution image onto the near area of the person.

13. The information projection apparatus according to claim 11,
wherein when the object is a person, the image projector performs blinking projection of a caution image onto the area of near the person, and a message is notified to the vehicle driver by voice.

14. The information projection apparatus according to claim 8,
wherein the image projector performs the normal projection, or the attention projection, or the warning projection, according to the movement direction and movement speed of the object and the vehicle.
